(19) United States
(12) Patent Application Publication
(10) Pub. No.: US 2009/0032533 A1
(43) Pub. Date: Feb. 5, 2009

(54) Flow switch and container

(75) Inventors: Michael R. Kessell, Auckland (NZ); Paul Neville Adams, Auckland (NZ); Steven L. Weir, Auckland (NZ); Henry Bolanos, Norwalk, CT (US)

Correspondence Address: EDWARDS ANGELL PALMER & DODGE LLP, P.O. BOX 55874, BOSTON, MA, 02205, US

(73) Assignee: Axial Technologies Ltd.

(21) Appl. No.: 11/825,577

(22) Filed: Jul. 6, 2007

Related U.S. Application Data
(63) Continuation-in-part of application No. 11/640,009, filed on Dec. 15, 2006.
(60) Provisional application No. 60/818,825, filed on Jul. 6, 2006.

(51) Int. Cl. B65D 43/26; F16K 5/00

(52) U.S. Cl. 220/262; 251/309

(57) ABSTRACT

A flow switch assembly which includes a valve housing that includes an upper body portion and a lower body portion that are rotatably engaged relative each other. The upper and lower body portions define a chamber. The housing includes an inlet and outlet to the chamber. A valve member seated in the chamber of the valve housing for movement between an open position establishing at least one passage between the inlet and the outlet and a closed position wherein the at least one passage between the inlet and the outlet is non-established. Interactive cam elements are associated with at least one of the upper body portion and the lower body portion, and associated with the valve member, are provided for moving the valve member between the open position and the closed position when the upper body portion of the housing is rotated relative to the lower body portion.

### CROSS REFERENCE TO RELATED APPLICATIONS

This application is a continuation-in-part of U.S. application Ser. No. 11/640,009 filed Dec. 15, 2006 and further claims priority from U.S. application Ser. No. 11/413,741 filed Apr. 28, 2006, which in itself claims priority from U.S. Provisional Patent Application Ser. No. 60/675,668 filed Apr. 28, 2005; and the subject application further claims the benefit of priority from U.S. Provisional Patent Application Ser. No. 60/818,825 filed Jul. 6, 2006, the disclosures of each of said applications are herein incorporated by reference in their entireties.

### FIELD OF THE INVENTION

The present invention relates to a flow switch. Specifically although not solely the present invention relates to a flow switch for or of a consumer beverage container such as a beverage or water bottle, that incorporates the switch at the spout end of the container to control the dispensing of liquid from the container.

Specifically although not solely the present invention may also relate to a flow switch that may have application other than for beverage container applications and that will hereinafter be described with reference to the drawings and detailed descriptions.

Further, the subject invention relates generally to the field of sealing mechanisms, and more particularly to, a compact valve assembly for use in a variety of applications, which includes a valve member that is readily actuated between the open and the closed position by a camming mechanism.

Even further, the present invention relates to improvements to flow switch actuation. Specifically although not solely the present invention relates to such improvements for a flow switch for or of a consumer beverage container such as a beverage or water bottle, preferably of a disposable kind, which incorporates a flow switch at the spout end of the container to control the dispensing of liquid from the container.

Specifically although not solely the present invention may also relate to a flow switch which may have application other than for beverage container applications.

### BACKGROUND

Ball valves are well known to those skilled in the art and are commonly used in a variety of applications and industries. Typically, in applications that concern controlling the flow of a fluid, an apertured ball valve is selected. In an apertured ball valve, a generally spherical valve member that has a flow aperture or passage formed therethrough is positioned for rotational movement within a valve housing. The valve operation or function is broken down into two separate stages. First, the ball moves between an open and a closed position by rotating through 90 degrees, such that the aperture or flow passage moves from an orientation coaxial with the flow direction, i.e. when the valve is open, to a position whereby the ball aperture is normal or perpendicular to the flow direction. Second, the valve seals in the closed position to prevent flow through the aperture across the ball valve. Therefore, the on-off control of flow through the valve is achieved by rotating the ball through 90 degrees within the valve housing.

In prior art ball valves; the rotation of the ball (i.e., valve member) is typically effectuated by an actuator mechanism that protrudes from the valve housing and is configured to rotate about an axis perpendicular to that of the valve flow. Such a valve is disclosed in U.S. Pat. No. 6,695,285 to Hotton et al.

Several disadvantages are associated with this type of ball valve. For example, the extension of an actuator from the sidewall of the valve is cumbersome and not desirable for applications where space limitations and physical access to the actuator are a concern. Still further, the actuator in these valves must be rotated or turned through at least 90 degrees in order for the valve to move between the fully open and fully closed positions.

Therefore, it would be beneficial therefore, to provide a valve/seal mechanism that is compact, reliable and readily actuated between the open and closed position and actuated with a minimal amount of rotational movement.

Further, drink containers that are currently in common use for the purposes of containing liquid such as water are common. They normally incorporate a spout that is engaged by a valve to control the dispensing of the liquid from the reservoir of the container. A valve used for such applications is for example described in U.S. Pat. No. 6,758,359. It consists of a valve housing and a movable valve element that moves in an axial direction to open and close the spout.

The valve unit of U.S. Pat. No. 6,758,359 can have significant limitations and disadvantages. When such a valve is used by a consumer the yalve element can require considerable force to move it between opened and closed conditions. Consumers often utilize their teeth to grasp the movable valve element to open it. This can damage teeth, particularly of younger persons having teeth that may not be able to withstand the considerable force required to open the valve unit.

The valve unit of U.S. Pat. No. 6,758,359 is also generally only capable of having a single purpose, being to open and close an outlet opening. It would be an advantage if a bottle could contain a valve that could be utilized for other purposes or have additional functionality.

Whilst in the applicant's published PCT application WO2004/106782 reference is made to the use of a valve for use with a beverage container, the valve largely only has an open/closed function. Further enhancements are desirable, other applications utilizing a more efficient valve to perform sealing or to provide further functionality would be beneficial.

In this specification where reference has been made to patent specifications and other external documents, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is a further object of the present invention to provide a flow switch which provides improvements over that disclosed in WO2004/106782 or which will at least provide the public with a useful choice.

### BRIEF DESCRIPTION OF THE INVENTION

In a first aspect the present invention consists in a flow switch assembly comprising;

(a) a valve housing that includes an upper body portion and a lower body portion that are rotatably engaged relative each other, the upper and lower body portions defining a chamber, the housing including an inlet and outlet to said chamber

(b) a valve member seated in the chamber of the valve housing for movement between a position (herein after “open position”) establishing at least one passage between said inlet and said outlet and a position (herein after “closed position”) wherein said at least one passage between said inlet and said outlet is non-established (preferably by said valve member sealing at least one of said inlet and outlet),

(c) interactive cam elements associated with (i) at least one of (a) said upper body portion and (b) said lower body portion, and (ii) the valve member, the cam elements positioned to effect movement of the valve member between the open position and the closed position when the upper body portion of the housing is rotated relative to said lower body portion.

Preferably when said valve member is in said open position, said valve member establishes at least one passage between said inlet and outlet.

Preferably said valve member is seated by said valve housing for rotation relative to said valve housing, about a first axis.

Preferably the moving of said valve member between the open position and the closed position by said cam elements is actuated when the upper body portion of the housing is rotated relative to said lower body portion about its axis of rotation that is perpendicular to said first axis.

Preferably said inlet is provided by said lower body portion and said outlet is provided by said upper body.

Preferably said inlet and said outlet are provided in diametrically of said valve member opposed locations.

Preferably the cam elements include (i) at least one cam surface formed at the exterior surface of the valve member and (ii) a cam follower formed at the interior surface of the upper body portion of the housing.

Preferably the cam elements include (i) at least one cam surface formed into the exterior surface of the valve member and (ii) a cam follower formed on the interior surface of the upper body portion of the housing.

Preferably the cam surface is defined by a slot into which the cam follower is located.

Preferably said valve member is seated in said chamber and mounted by axles positioned diametrically opposed to said valve member, for rotation relative to said valve housing about a first axis, and wherein said lower body portion is engaged (directly or indirectly) to said upper body portion to rotate relative to each other about an axis that is non parallel to said first axis wherein said cam elements include a cam follower and at least one cam surface with which said cam follower interacts, said cam follower carried by said upper body portion to rotate along an arc about said second axis lying in a plane perpendicular said second axis where said arc passes through a plane passing through and parallel said first and second axes and wherein said at least one cam surface defines two regions for engagement by said cam follower, a first region to be engaged by said cam follower when said cam follower is rotated toward a first distal end of said arc and a second region to be engaged when said cam follower is rotated towards the other distal end of said arc, said engagement effecting said rotation of said valve member about said first axis

Preferably said first and second axes are perpendicular to each other.

Preferably arc is bisected by said plane passing through and parallel said first and second axes.

Preferably said first and second regions are each disposed proximate one of said axles.

Preferably said first and second regions are each disposed on the same side as the upper housing of a plane in passing through and parallel said first axis and to which said second axis is normal.

Preferably said first and second regions of said at least one cam surface each define a surface of said at least one cam that are intersected by a plane in which said arc sits, at least when said valve member is intermediate of said open and closed positions.

Preferably said first and second regions are each defined by a discrete said cam surface.

Preferably a single said cam surface is defined that is of a V or U-shaped configuration to define said first and second regions.

Preferably said at least one cam surface is defined by two lobes on the valve member positioned in a “V” shaped configuration of said first and second region.

Preferably said lower body portion provides said inlet to said chamber, and wherein said lower body portion is integrally formed with a container.

Preferably said container is a consumer beverage container.

Preferably a second valve housing is provided, said second valve housing including an upper body portion (the “second upper body portion”) and a lower body portion (the “second lower body portion”), the second upper and lower body portions defining a chamber (the “second chamber”) capturing a valve member (the “second valve member”), the second valve housing including and inlet and outlet to said second chamber,

said second valve member seated in the second chamber of the second valve housing for movement between a position (herein after “open position”) defining a passage (the second passage) between said inlet and said outlet of said second valve housing and a position (herein after “closed position”) wherein said second passage is non-established (preferably by said second valve member sealing at least one of said inlet and outlet of said second chamber),

interactive cam elements associated with said second valve housing and the second valve member for moving the second valve member between the open position and the closed position when the second upper body portion of the second valve housing is rotated relative to said second lower body portion,

wherein a duct is provided intermediate of or defined by said first mentioned upper body portion and said second lower body portion to define a passage between the first mentioned outlet and said second inlet wherein said duck may preferably include an opening.

Preferably said first mentioned upper body portion is engaged or integrally formed with said second lower body portion.

Preferably said first mentioned valve member can move independently of said second valve member.

Preferably said duct retains a tablet.

Preferably said first mentioned inlet is of a size to allow the passing of said tablet from said duct through said inlet when said first mentioned valve member is in said open position.

Preferably, when said valve member is in said open position, said valve member establishes a plurality of said passages between said inlet and outlet.

Preferably said valve member includes a plurality of ducts to define at least two of said passages and wherein at least one of said lower and upper body portions includes a plurality of said inlet and outlets respectively, each duct of said plurality of ducts capable, upon the rotation of said valve member, of moving into and out of a said open position being one where at least one passage is established between (i) an or the inlet of said lower body portion and (ii) an or the outlet of said upper body portion.

Preferably each said plurality of ducts are mutually exclusive in providing a passage between an or the said inlet and an or the outlet, to the other of said plurality of ducts or ducts of said valve member.

Preferably said valve member has a plurality of ducts to each define a said passage at different angles of rotation of said valve member other than when said valve member is in the closed position.

Preferably said plurality of ducts are discrete ducts through said valve member.

Preferably said plurality of ducts is a bifurcated duct.

Preferably said valve member includes a duct therethrough via which said passage is established, said duct including an outlet opening, said valve member being shaped to present said outlet opening projecting beyond said outlet of said housing when said valve member is in said open position.

Preferably a removable overcap is provided, said housing engageable with a removable overcap to conceal said outlet of said housing.

Preferably said overcap can engage with said housing only when said valve member is not in said open position.

Preferably said upper and lower body portions each include overcap receiving regions, said receiving regions of said upper and lower body portions being movable relative to each other to be in and out of register with each other, wherein when in register they are only then capable of engaging said overcap with said housing, said means to engage being in register only when said valve member is not in said open condition.

Preferably a ring is provided to engage about at least part of both of said upper and lower body portions to lock relative rotation there between until such time as said ring is released from said upper and lower body portion.

Preferably said upper and lower body portions include a receptacle to receive a locking element to lock relative rotation of said upper and lower body portions, said receptacle being defined by both said upper and lower body portions.

Preferably said upper body portion and said lower body portion are rotatably engaged with each other to allow relative rotation about an axis, there being provided by said upper and lower body portions a means cooperative to, at a rotational position of said upper and lower body portions corresponding to the valve member being in at least one of said open and closed position, draw said upper and lower body portions together more to thereby effect a clamping of the valve member by said housing to encourage said valve member to thereby sealingly engage one of said inlet and outlet.

Preferably said means cooperative is a cam and cam follower provided by said upper and lower body portions respectively.

Preferably said means cooperative are complementary threads is provided by way of a threaded engagement of said upper and lower body portions.

Preferably said clamping by said valve housing with said valve member occurs at least one of said inlet and outlet to said chamber to seal against said valve member about said inlet and/or outlet.

Preferably one of said upper and lower body portions includes a skirt region with an internally presented interface region to interface with an externally presented interface region of the other of said upper and lower body portions to hold said upper and lower body portions together for said relative rotation about said axis, said skirt region including a cam surface providing cam surface deviation in a direction parallel to said axis and over which a cam follower of the externally presented interface can slide, said deviation being such that the cam follower is displaced in a direction parallel to said axis by said cam surface.

Preferably said upper body portion and said lower body portion are rotatably engaged with each other to allow relative rotation about an axis, and wherein said upper and lower body portions can displace relative each other in a direction parallel the axis, said displacement controlled by a threaded engagement of said upper and lower body portions said threaded engagement being such that at a rotational position of said upper and lower body portions corresponding to the valve member being in at least one of said open and closed position, said upper and lower body portions are in a more proximate displacement to effect a clamping of the valve member by said housing to encourage said valve member to thereby sealingly engage one of said inlet and outlet.

Preferably said upper body portion and said lower body portion are rotatably engaged with each other to allow relative rotation about an axis, and wherein said upper and lower body portions can displace relative each other in a direction parallel the axis, said displacement controlled by a ramped surface of at least one of said upper and lower body portions interacting with a reaction surface or like ramped surface of the other of said upper and lower body portion at a rotational position of said upper and lower body portions corresponding to the valve member being in at least one of said open and closed position, said upper and lower body portions are in a more proximate displacement to effect a clamping of the valve member by said housing to encourage said valve member to thereby sealingly engage one of said inlet and outlet.

Preferably said upper and lower body portions are rotatable relative to each other about an axis, the rotation being indexed by indexing means of said valve housing cooperating between said upper and lower body portions.

Preferably said indexing means encourages the holding of a relative rotational position (herein after “an index position”) of said upper an lower body portions.

Preferably a said index position is when said upper and lower body portions are rotated relative to each other corresponding to said valve member being in said open condition.

Preferably a said index position is when said upper and lower body portions are rotated relative to each other corresponding to said valve member being in said closed condition.

Preferably a plurality of said index positions are provided.

Preferably a spring is provided to bias the rotation of said valve member for rotation towards one of said open and closed conditions.

Preferably said spring is mounted to act between said valve member and said lower body portion to bias said valve member.

Preferably said spring is mounted to act between said upper and lower body portions to bias their relative rotation to bias said valve member.

Preferably said valve member is mounted by said lower body portion by axles that define an axis of rotation about which said valve member can rotate and relative to which said lower body portion remains stationary and said upper body portion can rotate about said axis relative said lower body portion that is non parallel to said first axis.

In a further aspect the present invention consists in a consumer beverage container comprising;

a container portion

a lower valve body portion integrally formed with said container portion,

an upper valve body portion rotatably engaged with said lower valve body portion and defining with said lower valve body portion a chamber, said lower valve body portion including at least one passage creating an inlet to said chamber to allow fluid passage between said container portion and said chamber, the upper valve body portion including an outlet to said chamber,

a valve member seated in the chamber, said valve member mounted for movement between a position (herein after “open position”) defining at least one passage between said inlet and said outlet and a position (herein after “closed position”) wherein said at least one passage between said inlet and outlet is non-established (preferably said valve member sealing at least one of said inlet and outlet),

means operatively associated with (i) at least one of (a) said upper and (b) lower valve body portions, and (ii) the valve member, for moving the valve member between the open position and the closed position when the upper valve body portion of the housing is rotated relative to said lower valve body portion.

In a further aspect the present invention consists in a consumer beverage container including a container defining body having an outlet for transferring fluid to and from said container defining body and a flow switch assembly as herein described to operatively control the transfer of fluid.

Preferably the lower body portion of said flow switch is integrally formed with said container defining body.

In a further aspect the present invention consists in a consumer beverage container comprising a container body portion having a flow switch assembly controlled outlet wherein said flow switch assembly is one as herein described.

Preferably said first mentioned lower body portion is integrally formed with said container defining body.

Preferably said first mentioned lower body portion is engaged with said container body portion.

In a further aspect the present invention consists in a flow switch assembly comprising;

(a) a valve housing that includes an upper body portion and a lower body portion that are rotatable relative each other, the upper and lower body portions defining a chamber, said lower body portion including a plurality of inlets to said chamber and said upper body portion including at least one outlet to said chamber,

(b) a valve member seated in the chamber of the valve housing, said valve member mounted for movement relative to said valve housing between discrete positions each of said discrete positions allowing the establishment by said valve member of a passage between one of said inlets and (a) or the said outlet,

(c) interactive camming elements associated with said valve housing and the valve member for moving the valve member between the discrete positions when the upper body portion of the housing is rotated relative to said lower body portion.

Preferably said valve member is mounted for movement relative to said valve housing between discrete positions being ones (i) defining of a passage between a said inlet and a or the said outlet and (ii) defining a closed position, wherein said valve member seals at least one of (a) all of said inlets and (b) said outlet(s).

In a further aspect the present invention consists in a flow switch assembly comprising;

(a) a valve housing that includes an upper body portion and a lower body portion that are rotatably engaged to each other, the upper and lower body portions defining a chamber, said lower body portion including at least one inlet to said chamber and said upper body portion including a plurality of outlets to said chamber,

(b) a valve member seated in the chamber of the valve housing, said valve member mounted for movement relative to said valve housing between discrete positions each of said discrete positions allowing the establishing by said valve member of a passage between (a) or the said inlet and one of said outlets,

(c) interactive cam elements associated with said valve housing and the valve member for moving the valve member between the discrete positions when the upper body portion of the housing is rotated relative to said lower body portion.

Preferably said valve member is mounted for movement relative to said valve housing between discrete positions being ones (i) defining a passage between one of said outlets and a or the said outlet and (ii) defining a closed position, wherein said valve member seals at least one of (a) all of said outlets and (b) said inlet(s).

In a further aspect the present invention consists in a container comprising;

a housing that includes an upper body portion and a lower body portion, the upper and lower body portions defining a chamber, the housing including an outlet to said chamber,

a container member seated in the chamber of the housing, said container member including a reservoir to contain a substance and including at least one outlet for said substance, said container member mounted for movement between a position (herein after “open position”) allowing at least one passage to be formed between said outlet of said container member and said outlet to said chamber and a position (herein after “closed position”) wherein said container member seals said outlet of said chamber,

interactive camming elements associated with said housing and the container member for moving the container member between the open position and the closed position when the upper body portion of the housing is rotated relative to said lower body portion.

Preferably said container member includes only one outlet that is rotatable to be contiguous with said outlet of said housing when said container member is rotated to said open position.

Preferably, when said container member is in said open position, said container member establishes at least one passage to allow displacement of said substance between said fluid outlet and outlet of said housing.

Preferably said container member is mounted by said valve housing for rotation relative to said valve housing, about a first axis.

Preferably said container member is substantially spherical in its outer perimeter shape.

Preferably said chamber of said housing is of a substantially complementary shape to said spherical container member.

Preferably said housing includes at least one other outlet in addition to said first mentioned outlet and with which said outlet of said container member can create a passage to allow transfer of said substance from said reservoir.

Preferably said outlet(s) of said housing are provided by said upper body portion.

Preferably at least one tablet is disposed in said valve member and wherein at least one of

(a) said outlet; and

(b) said passage created when said valve member is in the open condition, prevents displacement of said tablet through said outlet when said valve member is in the open position yet said inlet is of a shape to allow said tablet to pass therethrough when said valve member is in said open position.

Preferably said valve element can include a tablet and wherein said outlet is of a shape that prevents the passage of said tablet through said outlet.

Preferably said outlet is of a smaller size than said inlet.

Preferably said passage is formed by at least one duct passing through said valve member, said duct having an inlet and an outlet that when in an open position of the valve member are presented to the inlet and outlet of said housing respectively to create said passage.

Preferably a said duct includes a constriction between said inlet and outlet.

Preferably said duct includes a tablet that is prevented by said constriction from displacing through said outlet of said valve member.

Preferably said duct includes a tablet that is prevented by said constriction from displacing through said outlet of said valve member.

Preferably said passage formed in the open position includes a constriction wherein said tablet is prevented by said constriction from displacing through said outlet of said valve member.

In a further aspect the present invention consists in a flow switch assembly comprising;

(a) a valve housing that includes an upper body portion and a lower body portion that are rotatably engaged relative each other, the upper and lower body portions defining a chamber, the housing including an inlet and outlet to said chamber

(b) a valve member seated in said chamber of the valve housing and rotatable about an axis of rotation between two limits of rotation, said valve member including a plurality of ducts each including an inlet and an outlet opening to said inlet and outlet of said housing to create at least two passages between said inlet and outlet of said housing wherein at least one of said passages is created at different rotational positions of said valve member between its limits of rotation,

(c) interactive cam elements operatively associated with (i) at least one of (a) said upper body portion and (b) lower body portion, and (ii) the valve member, for moving the valve member between its limits of rotation when the upper body portion of the housing is rotated relative to said lower body portion.

In another aspect the present invention consists in a flow switch assembly comprising;

a. a valve housing which includes an upper body portion and a lower body portion, the upper and lower body portions defining a chamber to capture a valve member, the housing including an inlet and outlet to said chamber, the upper body portion being rotatable relative the lower body portion and about a first axis of rotation, between a first rotational position and a second rotational position,

b. a valve member seated in the chamber of the valve housing, said valve member mounted for movement between a position (herein after “open position”) allowing fluid passage between and/or via said inlet and that corresponds to the first rotational position and said outlet and a position (herein after “closed position”) wherein said valve member seals at least one of said inlet and outlet and that corresponds to the second rotational position

c. at least one cam carried by the upper valve housing for rotational movement along a path about said first axis of rotation

d. a first cam follower carried by the valve member and presented in the path of the at least one cam when the upper body portion moves between the first position and the second position and towards the second position to be engaged by the at least one cam to thereby displace the valve member towards the closed position,

e. a second cam follower carried by the valve member and presented in the path of the at least one cam when the upper body portion moves between the first position and the second position and towards the first position to be engaged by the at least one cam to thereby displace the valve member towards the open position.

Preferably there are two cams, one of which is operative in moving the valve member toward the closed condition by its engagement with the first cam follower upon rotation of the upper housing towards its first position and the other of which is operative in moving the valve member toward the open condition by its engagement with the second cam follower upon rotation of the upper housing towards its second position.

Preferably each of the two cams are a lug.

Preferably the valve member is mounted for rotational movement within the housing about an axis of rotation (herein after “second axis of rotation”) that is non parallel the first axis of rotation.

Preferably the second axis of rotation is perpendicular the first axis of rotation.

Preferably the second axis of rotation is defined by two axles provided at opposite sides of the valve member.

Preferably the axles form part of the valve member and are located by journals of the lower body portion.

Preferably the axles form part of the lower body portion and are located by journals of the valve member.

Preferably the first cam follower is positioned proximate more a first of the axles as is its corresponding cam.

Preferably the second cam follower is positioned proximate more the first of the axles as its corresponding cam.

Preferably the second cam follower is positioned proximate more the second of the axles as is its corresponding cam.

Preferably the first and second cam followers are parallel each other and are each proximate a first of the axles, and wherein two cams are carried by the upper housing to each interact with a respective first and second cam follower.

Preferably the first and second cam followers are positioned radially relative to the axle.

Preferably the first and second cam followers present an arcuate surface for interaction with the cam(s).

Preferably when said valve member is in said open position, said valve member establishes at least one passage to allow fluid communication between said inlet and outlet.

Preferably said valve member is mounted by said chamber for rotation relative to said valve housing, about a first axis.

Preferably said inlet is provided by said lower body portion and said outlet is provided by said upper body.

Preferably said inlet and said outlet are provided in diametrically to said valve member opposed locations.

Preferably each of the cam followers is formed at the exterior surface of the valve member and a cam(s) is formed on the interior surface of the upper body portion of the housing.

Preferably each of the cam followers is formed into the valve member.

Preferably said lower body portion provides said inlet to said chamber, and wherein said lower body portion is integrally formed with a container said container including an opening contiguous said inlet to said chamber.

Preferably said container is a consumer beverage container.

In a further aspect the present invention consists in a consumer beverage container comprising;

a container portion that includes a lower valve body portion integrally formed with said container portion,

an upper valve body portion, rotatably engaged with said lower valve body portion and defining with said lower valve body portion a chamber to capture a valve member, said lower valve body portion including a passage creating an inlet to said chamber to allow fluid passage between said container portion and said chamber, the upper valve body portion including an outlet to said chamber,

a valve member seated by the chamber, said valve member mounted for movement between a position (herein after “open position”) allowing fluid passage between and/or via said inlet and said outlet and a position (herein after “closed position”) wherein said valve member seals at least one of said inlet and outlet,

a cam of at least one of (a) said upper and (b) lower valve body portions, and two cam followers of the valve member, to interact with each other for moving the valve member between the open position and the closed position when the upper valve body portion of the housing is rotated relative to said lower valve body portion.

In a further aspect the present invention consists in a fluid container comprising;

a housing which includes an upper body portion and a lower body portion, the upper and lower body portions defining a chamber capturing a container member, the housing including an outlet to said chamber,

a container member seated by the chamber of the housing, said container member including a reservoir to contain fluid and including at least one fluid outlet, said container member mounted for movement between a position (herein after “open position”) allowing fluid passage between and/or via said fluid outlet of said container member and said outlet to said chamber and a position (herein after “closed position”) wherein said container member seals said outlet of said chamber,

a cam of at least one of (a) said upper and (b) lower valve body portions, and two cam followers of the valve member, to interact with each other for moving the valve member between the open position and the closed position when the upper valve body portion of the housing is rotated relative to said lower valve body portion.

Preferably said container member includes only one fluid outlet which is rotatable relative to and to be contiguous with said outlet of said housing when said container member is rotated to said open position.

Preferably when said container member is in said open position, said container member establishes at least one passage to allow fluid communication between said fluid outlet and outlet of said housing.

Preferably said container member is mounted in said chamber for rotation relative to said valve housing, about a first axis.

Preferably the moving of said container member between the open position and the closed position by the interaction of the cam and cam followers is actuated when the upper body portion of the housing is rotated relative to said lower body portion about an axis which is perpendicular to said first axis.

In a further aspect the present invention consists in a flow switch as hereinbefore described and as described with reference to any one or more of the accompanying figures.

In a further aspect the present invention consists in a flow switch as described with reference to any one or more of the accompanying figures.

In a further aspect the present invention consists in a beverage container including a flow switch as hereinbefore described and as described with reference to any one or more of the accompanying drawings.

In a further aspect the present invention consists in a beverage container including a flow switch as described with reference to any one or more of the accompanying drawings.

In a further aspect the present invention consists in a beverage container as hereinbefore described and as described with reference to any one or more of the accompanying drawings.

In a further aspect the present invention consists in a beverage container as described with reference to any one or more of the accompanying drawings.

Where reference herein is made to a “valve” it is understand to be a reference to a “flow switch” of the kind herein described. Furthermore whilst reference may predominantly be made to such a flow switch or valve being used for beverage containers, it will be appreciated by a person skilled in the art that other applications for the control of fluid flow by the flow switch of the present invention can be catered for including but not limited to plumbing.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The subject application is directed to a valve/seal assembly that is adapted for use in a variety of applications, such as for example, medical, consumer beverage, pharmaceutical containers, automobile, household appliance and marine. The disclosed valve includes, inter alia, a valve housing having an upper body portion and a lower body portion and a generally spherical valve member. The upper and lower body portions of the housing define an internal chamber for accommodating the valve member and a central axis for the valve. The housing also has axially aligned inlet and outlet ports formed in the upper and lower body portions, respectively.

The generally spherical valve member is seated within the internal chamber of the valve housing and has an axial bore extending therethrough. The valve member is mounted for movement between an open position; wherein the axial bore of the valve member is axially aligned with the inlet and outlet ports of the valve housing, and a closed position; wherein the axial bore of the valve member is out of alignment with the inlet and outlet ports of the valve housing. Preferably, the valve member moves between the open position and the closed position when the upper body portion of the housing is rotated about the central axis between about 57 degrees and about 77 degrees with respect to the lower body portion. It is presently envisioned that the valve member is mounted for axial rotation within the interior chamber about an axis extending perpendicular to the central axis defined by the upper and lower body portion of the valve housing.

Preferably, the valve member includes a sealing surface adapted for sealing engagement with a valve seat formed in the housing when the valve is in the closed position. In applications where a pressure is applied to the fluid or air metered by the valve, the sealing surface of the valve member is adapted to include an annular recess having an o-ring disposed therein.

The valve assembly further includes a mechanism that is operatively associated with the valve housing and the valve member for moving the valve member between the open position and the closed position when the upper body portion of the housing is rotated about the central axis with respect to the lower body portion. In a preferred embodiment, the mechanism for actuating the valve assembly is a camming mechanism.

In a present embodiment, the camming mechanism includes cam surfaces formed on the exterior surface of the valve member and a cam pin formed on the interior surface of the upper body portion of the housing. It is envisioned that the cam surfaces formed on the exterior surface of the valve member are defined by a pair of cam lobes formed at angles to one another. The cam lobes can be arcuate or linear in configuration.

In a further embodiment of the present invention, the camming mechanism includes at least one arcuate recess formed on the exterior surface of the valve member and a cam pin formed on the interior surface of the upper body portion of the housing for engaging with the cam recess.

In a preferred embodiment, the housing for the valve assembly includes means associated with the inlet port for engaging the valve with a receptacle or tubing. Additionally, if desired, the housing can includes means associated with the outlet port for engaging the valve with a receptacle or tubing.

In applications that require the valve to include a tamper-proof feature to ensure the purity of the substance contained within the bore of the valve member or in the receptacle or container, upon which the valve is affixed to, the valve further includes a frangible ring engaged with exterior of the valve housing to provide a visual indication of whether the valve has been opened. Alternatively or in combination, the valve can include a frangible sealing disc inserted into the interior chamber of the valve to again provide a visual indication of whether the valve has been opened. This sealing disc also functions as a secondary seal for the valve until its initial use. In this embodiment, it is envisioned that the valve member includes a mechanism for puncturing the disc when the valve is opened. For example, a sharp protuberance can be formed on the bottom of the valve member which cuts the sealing disc when the valve is moved from the closed to the open position.

In an alternative embodiment, the axial bore of the valve member is adapted and configured for receiving and storing an article of manufacture when the valve is in the closed position. For example, an award or small prize may be stored in the bore and revealed when the valve is opened. Still further, the valve could be mounted to a water bottle and the bore of the valve could contain a vitamin or supplement which is dropped into the water when the valve is opened.

It is further envisioned that the valve can include a mechanism associated with the valve housing for facilitating the axial rotation of the upper body portion of the housing relative to the lower body portion.

In an alternative embodiment, a plurality of flow passages are formed in the valve member and extend therethrough along an axis that is perpendicular to the axial bore such that when the valve is in the closed position, fluid or air traverses the valve through the plurality of flow passages.

The present disclosure is also directed to a surgical access device which includes, among other things, a valve housing, an elongated cannula sleeve operatively associated with the housing, a generally spherical valve member disposed within an interior chamber defined in the housing and a mechanism operatively associated with the valve housing and the valve member for moving the valve member between the open position and the closed position.

The valve housing defines an interior chamber and a valve seat for accommodating the valve member. Axially aligned inlet and outlet ports are formed in the housing and extend from the valve exterior to the interior chamber.

The elongated cannula sleeve that is operatively associated with the valve housing, has an elongated passageway extending therethrough that defines a longitudinal axis aligned with the inlet and outlet ports of the valve housing. In a disclosed embodiment, the cannula sleeve depends from a cannula housing associated with the valve housing. It is envisioned that the cannula housing can be detachably connected to the valve housing.

The generally spherical valve member is seated within the valve housing and has an axial bore extending therethrough. The valve member is mounted for movement between an open position and a closed position. In the open position, the axial bore of the valve member is axially aligned with the elongated passageway of the cannula sleeve and the inlet and outlet ports of the valve housing. In the closed position, the axial bore of the valve member extends perpendicular to the elongated passageway of the cannula sleeve and the inlet and outlet ports of the valve housing. It is envisioned that the valve member is mounted for axial rotation within the valve interior chamber about an axis extending perpendicular to the axially aligned inlet and outlet ports of the valve housing.

It is presently envisioned that the valve member includes a convex sealing surface, which is aligned with the inlet port of the valve housing when the valve member is in the closed position. In alternative embodiments that require a pressure tight seal, the sealing surface of the valve member includes an annular recess having an o-ring disposed therein.

In a preferred embodiment, the mechanism for moving the valve member includes cam surfaces formed on the exterior surface of the valve member and a cam pin mounted for movement relative to the cam surfaces of the valve member. Preferably, the cam pin extends radially inwardly from a drive ring supported on the valve housing and mounted for rotation about the longitudinal axis of the cannula sleeve. The rotation of the drive ring causes corresponding rotation of the valve member within the valve seat of the valve housing.

In a disclosed embodiment of the surgical access device, the cam surfaces formed on the exterior surface of the valve member are defined by a pair of cam lobes oriented with respect to the axis of rotation of the valve member at angles to one another.

In an alternative embodiment, the mechanism operatively associated with the valve housing and the valve member for moving the valve member between the open position and the closed position includes at least one arcuate recess formed on the exterior surface of the valve member and a cam pin formed on the interior surface of the housing for engaging with the cam recess.

It is presently preferred that the surgical access device further includes a membrane seal located proximal to the valve seat, the membrane seal having an opening axially aligned with the elongated passageway of the cannula sleeve. The opening is dimensioned to accommodate the passage of a surgical instrument therethrough.

Those skilled in the art would readily appreciate that the components of the disclosed valve assembly, or portions thereof, may be manufactured from any rigid, semi-rigid, hard or semi-hard material, such as plastic, rubber, metal or a composite. Still further, in medical applications the valve assembly can be made out of titanium or a similar biocompatible material.

Additionally, the generally spherical valve member can be formed to have an interference fit with the valve seat so as to provide a tighter seal. By forming the valve member or valve seat slightly out-of-round, a tighter seal is created and more force is required to open the valve.

It is also envisioned that a telescoping nozzle or sleeve can be disposed within the axial bore of the valve member and when the valve is moved to the open position, the nozzle or sleeve extends out of the valve inlet. This feature is useful in a variety of applications, such as for example, beverage or gasoline containers.

Still further, it is envisioned that the valve assembly of the present invention can be connected to stepper motor and thereby be operated remotely.

### BRIEF DESCRIPTION OF THE DRAWINGS

For convenient references aspects of the present invention are explained with and without reference to prior art by way of the drawings in which;

FIG. 1 is a perspective view of a valve assembly constructed in accordance with a preferred embodiment of the subject invention;

FIG. 2 is an exploded perspective view from above of the valve assembly of FIG. 1 with parts separated for ease of illustration;

FIG. 3 is an exploded perspective view from below of the valve assembly of FIG. 1 with parts separated for ease of illustration;

FIG. 4 is an exploded perspective view of an alternative embodiment of the valve assembly of the present invention with parts separated for ease of illustration, wherein the valve includes a frangible ring;

FIG. 5 is an exploded perspective view of an alternative embodiment of the valve assembly of the present invention with parts separated for ease of illustration, wherein the valve includes a sealing disc disposed within the interior chamber of the housing;

FIG. 6 is a perspective view of a valve assembly constructed in accordance with an alternative embodiment of the subject invention, wherein the valve assembly is engaged with a beverage container and is adapted for engagement with a cap;

FIG. 7 is a perspective view of a valve assembly constructed in accordance with an alternative embodiment of the subject invention with parts separated for ease of illustration, wherein a prize is stored within the bore formed in the valve member;

FIG. 8 is a perspective view of a valve assembly constructed in accordance with a further alternative embodiment of the subject invention, wherein the valve assembly is mounted on the end of a tubing which is in fluid communication with a container;

FIG. 9 is a perspective view of a valve assembly constructed in accordance with a further alternative embodiment of the subject invention, wherein the valve assembly is mounted on a container and a straw assembly is position within the open valve;

FIG. 10 is a perspective view of the valve assembly of the present disclosure which illustrates the valve positioned between two containers;

FIG. 11 is a perspective view of the valve assembly of the present disclosure adapted for use with a colostomy bag;

FIG. 12 is a perspective view of the valve assembly of FIG. 11 with parts separated for ease of illustration;

FIG. 13 is an exploded perspective view of an alternative embodiment of the presently disclosed valve assembly with parts separated for ease of illustration, wherein the valve member includes a plurality of flow passages extending through the valve perpendicular to the central bore;

FIG. 14 is a perspective view of an alternative application for the valve assembly of the present invention, wherein the valve is used in a automobile fuel tank;

FIG. 15 is a perspective view of a surgical access device constructed in accordance with a preferred embodiment of the subject invention;

FIG. 16 is an exploded perspective view of the surgical access device of FIG. 15 with parts separated for ease of illustration;

FIG. 17a is a perspective view in partial cross-section of the valve housing, which forms part of the surgical access device of FIG. 15, wherein the valve member is shown in an open position with the axial bore of the valve member aligned with the axially aligned inlet and outlet ports of the valve;

FIG. 17b is a perspective view in partial cross-section of the valve housing of the subject invention, wherein the valve member is in transition from the open position of FIG. 17a to the closed position of FIG. 17c;

FIG. 17c is a perspective view in partial cross-section of the valve housing of the subject invention, wherein the valve member is disposed in a closed position so that the axial bore of the valve member is oriented perpendicular to the axially aligned inlet and outlet ports of the valve housing;

FIG. 18 is a perspective view of another embodiment of the surgical access device of the subject invention, which includes a detachable valve housing; and

FIG. 19 is a perspective view of the surgical access device of FIG. 18, with the valve housing separated from the cannula housing for ease of illustration.

FIG. 20 is a perspective view of a valve assembly of WO2004/206782,

FIG. 21 is an exploded view of the valve assembly of FIG. 20,

FIG. 22 is an exploded view in an alternative direction and of slight variation to the valve assembly of FIG. 20,

FIG. 22A illustrates the fluid of FIG. 20 engaged with a consumer beverage container and wherein the valve member is shown in an open condition,

FIG. 22B shows the valve member positioned intermediate of a fully open and fully closed condition of the valve assembly,

FIG. 22C illustrates the valve member in a condition where the assembly is fully closed,

FIG. 23 is a perspective view of the assembly of FIG. 20 engaged with a consumer beverage container and also illustrating an overcap,

FIG. 24 is an exploded view showing the components of the assembly of FIG. 23,

FIG. 25 is a side view of a valve member illustrating an alternative configuration of lugs and camming pins to that shown in the FIGS. 20-24,

FIG. 26 illustrates the same valve member as shown in FIG. 24, but wherein the valve member has been rotated,

FIG. 27 is a perspective view of a valve member showing longitudinal and latitudinal designations for the purposes of illustrating the mechanism of movement,

FIG. 28 is an end view of a valve member looking onto the pole for the purposes of illustrating the mechanism of movement of the valve member,

FIG. 28a is a view from another side of the valve member of FIG. 28 illustrating an undesired positioning of the cam pin relative to the valve member 5,

FIG. 28b is an end view like the end view shown in FIG. 28 illustrating the cam lobes of the valve member 5,

FIG. 28c is a side view of a valve member showing a cam surface of a continuous form rather than being defined by two discrete cam lobes as shown in FIG. 28b,

FIG. 29 illustrates a flow switch engaged with a beverage container,

FIG. 29a illustrates the top end of a consumer beverage container having integrally formed, a lower body portion of the valve housing,

FIG. 30 is a side view of a flow switch assembly variation wherein provided are two valve members; a single upper body portion and two lower body portions, relative to which the upper body portion can rotate the upper body thereby simultaneously controlling two valve members,

FIG. 30a is a plan view of a valve member illustrating a passage not extending through the valve member but created in part by the valve member,

FIG. 30b is a side view of the valve member of FIG. 30a,

FIG. 30c illustrates a variation to the configuration shown in FIG. 30,

FIG. 30d illustrates a further variation,

FIG. 30e illustrates yet a further variation to those shown with reference to FIGS. 30, 30c and 30d,

FIG. 31 is a side view of a flow switch assembly in part shown in cross section wherein the valve member is not of an entirely spherical shape but includes a cutaway region to define a spout of the valve member,

FIG. 32 is a plan view of the assembly of FIG. 31,

FIGS. 33-36a illustrate multiple flow path enabling variations of a flow switch assembly of the present invention,

FIG. 37 illustrates in cross section a flow switch assembly variation wherein no inlet port is provided and where the valve member defines a cavity for containing the fluid to be dispensed through the outlet,

FIG. 38 is a perspective view of an overcap to be utilised with a flow switch assembly in a manner such that the overcap can only be engaged when the flow switch assembly is in a closed condition,

FIG. 39 is a side and partial sectional view of a flow switch assembly with apertures to be aligned between the upper and lower body portions to receive the legs of the overcap as shown in FIG. 38 to allow the overcap to only be engageable with the flow switch assembly when the flow switch assembly is in the closed condition as shown in FIG. 38,

FIG. 39a is a perspective view of a variation to the lock described with reference to FIGS. 38 and 39,

FIG. 39b is a further variation to that shown in FIGS. 38, 39 and 39a,

FIG. 40-43 illustrate various views of a flow switch assembly incorporating a wedge or cam like element for the purposes of assisting in creating a tight seal at and immediately prior to where the valve member is in a substantially closed and/or open condition,

FIG. 40A is a plan view of for example the flow switch assembly of FIG. 40 wherein driving surfaces are provided to one or both of the upper or lower body portions to allow for a crescent or other driving device to be selectively engaged therewith,

FIG. 41 is a sectional view through a flow switch assembly illustrating a cam or wedge like arrangement for the purposes of sealing the valve member when in either the closed or opened condition,

FIG. 41A is a perspective view of the lower body portion illustrating an example of a wedge like member for engagement with an interactive portion either a lug upstand rebate or a wedge like or cam like follower of the upper body portion,

FIG. 42 is a sectional view of FIG. 41 wherein the valve member is shown in an intermediate position,

FIG. 43 is a view of FIG. 41 but wherein the valve member is in a fully open position,

FIG. 44 is a side view of a flow switch assembly illustrating the incorporation of a spring biased lug that can be utilized to establish indexing or ratchet like relative positioning of the lower and upper body portions to allow for the valve member to be moved to discrete angular rotations, having particular application where there is multi port alignment capabilities provided by the flow switch assembly as for example shown in FIGS. 33-36,

FIG. 44a is an alternative side view of a flow switch assembly illustrating the incorporation of ratchet surfaces that can mate with each other for the purposes of an indexed locking of the upper and lower housing or providing an interference fit between the upper and lower housings to restrict or restrain or limit relative movement,

FIG. 45 is a plan view of a flow switch assembly in schematic illustrating how the flow switch assembly may include a spring to encourage one of the upper or lower body portions to be biased in one rotational direction relative to the other,

FIG. 46 is a side view of a valve member illustrating an alternative position of the cam lobes,

FIG. 47 is a front view of the valve member of FIG. 27,

FIG. 48 illustrates a flow switch assembly showing non-axially aligned inlet and outlet ports and a non-axial passage passing through or defined by the valve member,

FIG. 49 illustrates the flow switch of FIG. 29 but in a closed condition,

FIG. 50 illustrates a variation to a valve assembly of the present invention which is for example integrally formed with a container and wherein the valve assembly can contain a tablet or pill or solid which can only be dispensed into the container and not through the outlet, and

FIG. 51 illustrates a variation of the valve assembly of FIG. 50.

FIG. 52 shows a variation of the valve wherein no inlet is provided and where the passage acts as a reservoir instead,

FIG. 53 is a side view of a valve member illustrating an alternative configuration of lugs and camming pins to that shown in the FIGS. 52-54,

FIG. 54 illustrates the same valve member as shown in FIG. 61, but wherein the valve member has been rotated,

FIG. 55 illustrates a variation to the cam pin arrangement where the cam pin consists of two discrete elements that interact with cam lobes of the valve member,

FIG. 56 illustrates a valve member wherein a cam pin of a different configuration to that shown with reference to the preferred forms of the invention is provided,

FIG. 57 is a view of a valve member wherein the cam lobes of the upper body portion are of a curved configuration,

FIG. 58 is a view of a valve member and showing cam lobes of a circular configuration, and

FIG. 59 shows a variation wherein the cam lobes are surfaces that are parallel each other.

### DETAILED DESCRIPTION OF THE INVENTION

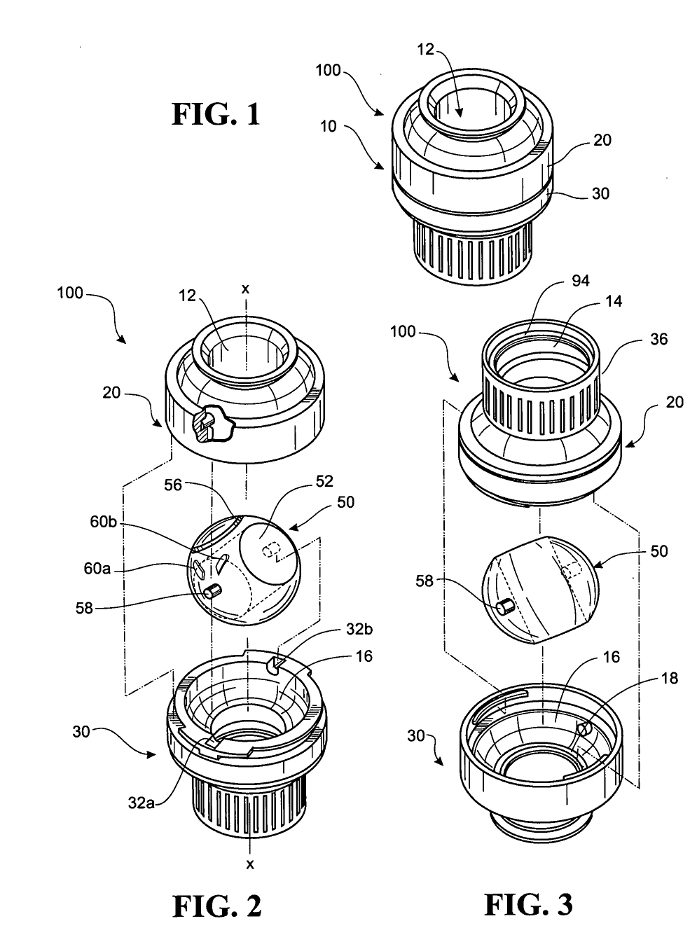

Referring now to FIGS. 1-19, wherein like reference numerals identify similar structural elements or features of the subject invention, there is illustrated in FIG. 1 a valve assembly in accordance with the present invention and designated generally by reference number 100. Valve assembly 100 is adapted for use in a variety of applications, such as for example, medical, consumer beverage, pharmaceutical containers, automobile, household appliance and marine. Valve 100 includes, inter alia, a valve housing 10 having an upper body portion 20 and a lower body portion 30 and a generally spherical valve member 50. The upper and lower body portions 20/30 of the housing 10 define an internal chamber 16 for accommodating the valve member 50 and a central axis “X” for the valve. The housing 10 also has axially aligned inlet and outlet ports, 12 and 14 respectively, formed in the upper and lower body portions, 20 and 30 respectively.

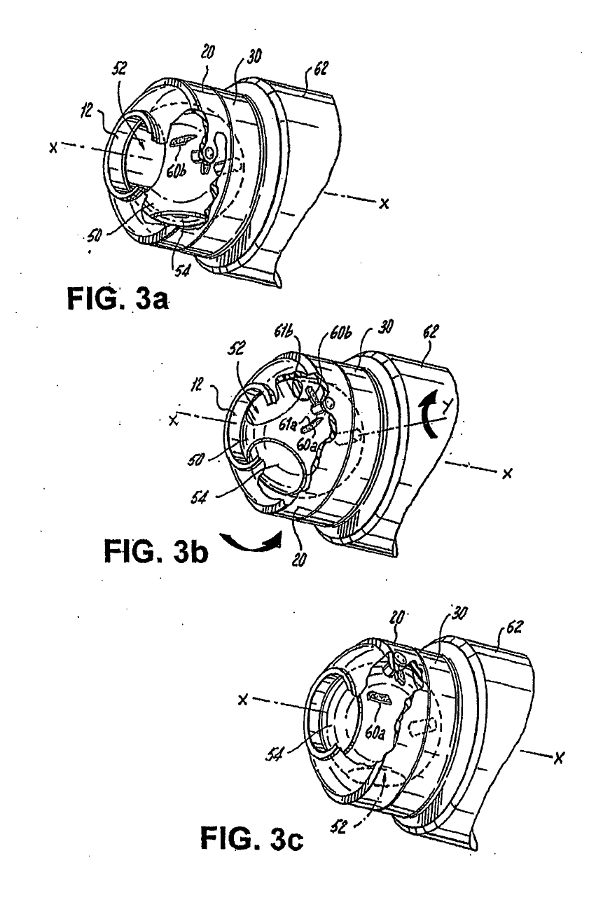

The generally spherical valve member 50 is seated within the internal chamber 16 of the valve housing and has an axial bore 52 extending therethrough. The valve member 50 is mounted for movement within the internal chamber 16 of the housing 10 between an open position and a closed position. FIG. 3a illustrates valve assembly 100 in the open position; wherein the axial bore 52 of the valve member 50 is axially aligned with the inlet port 12 and outlet port 14 of the valve housing 10. In a like manner, FIG. 3c illustrates the valve assembly 100 in the closed position; wherein the axial bore 52 of the valve member 50 is out of alignment with the inlet and outlet ports 12/16 of the valve housing 10. FIG. 3b, provides a detail of the valve assembly 100 in an intermediate position. It should be noted that in FIGS. 3a through 3c, valve assembly 100 is shown mounted on the neck of a container 62.

With continuing reference to FIGS. 3a through 3c, valve member 100 moves between the open position and the closed position when the upper body portion 20 of the housing is rotated about the central axis “X” between about 57 degrees and about 77 degrees with respect to the lower body portion 30. The valve member 100 is mounted for axial rotation within the interior chamber about an axis “Y” (see FIG. 3b) extending perpendicular to the central axis “X” defined by the upper and lower body portions 20/30 of the valve housing 10.

The valve member 50 includes a sealing surface 54 which is adapted for sealing engagement with annular valve seat 18 formed in the housing 10 when the valve is in the closed position. In applications where a pressure is applied to the fluid or air that is metered by the valve assembly, the sealing surface 54 of the valve member 50 includes an annular recess 56 (see FIG. 2) having an o-ring (not shown) disposed therein.

Diametrically opposed pivot pins 58 (only one pin is shown in FIG. 2) extend radially outwardly from the surface of valve member 50 for accommodation within diametrically opposed recesses 32a and 32 formed in the lower body portion 30 of the housing 10 to facilitate the axial rotation of valve member 50.

A camming mechanism is operatively associated with the valve housing 10 and the valve member 50 for moving the valve member 50 between the open position of FIG. 3a and the closed position of FIG. 3c. The camming mechanism includes cam lobes 60a, 60b formed on the exterior surface of the valve member 50 and a cam pin 22 which extends radially inwardly from the interior surface of the upper body portion 20 of the housing 10 to cooperate with the cam lobes. As will be described in detail herein below, the valve assembly can be equipped with a drive ring which is engaged over the upper body portion of the housing. In such an embodiment, the cam pin can be associated with the drive ring such that the drive ring actuates the valve member.

Referring again to FIG. 3b, the cam lobes 60a, 60b are oriented with respect to the axis of rotation “Y” of the valve member 50 at angles to one another. Each cam lobe 60a, 60b has a leading edge 61a, 61b that interacts with the cam pin 32. This interaction facilitates movement of the valve member 50 when the upper body portion 20 is rotated about the longitudinal axis X of the valve assembly 100. When the valve member 50 is moved between the open and closed positions, it is rotated about the pivot axis “Y” which extends through the pivot pin 58 of valve member 50, as illustrated in FIG. 3b.

Those skilled in the art would readily appreciate that in lieu of the cam lobes 60a and 60b, a single arcuate recess or pair of recesses can be formed in the exterior surface of valve member 50. In this embodiment, the length of cam pin 22 would be selected so that it extends into the camming recess(es) and actuates the valve member 50 between the open and closed positions upon the relative axial rotation of the two body portions 20/30 of the housing 10 with respect to each other.

Referring again to FIGS. 2 and 3, the lower body portion 30 of valve assembly 100 has a female thread series 34 formed thereon for engaging with corresponding male series associated with a receptacle (e.g. bottle, container, etc.), tubing or the like. Ribbed surface 36 is provided on the exterior of the lower body portion 30 of the housing 10 to facilitate the rotational engagement of the threads.

A water pressure test was conducted on a valve assembly similar to that described above. The entire valve was manufactured from a rigid thermoplastic and did not include O-ring seals. The camming lobes were constructed such that 67 degrees of rotation was required to move the valve between the open and the closed position. The axial bore of the valve was approximately ¾″ in diameter. Six feet of water was applied to the valve through a ⅜″ tube that was secured to the valve outlet. No leaking of the valve was observed and therefore, it was concluded that this embodiment of the valve assembly was capable of sealing fluid at a pressure of 3 psi (minimum).

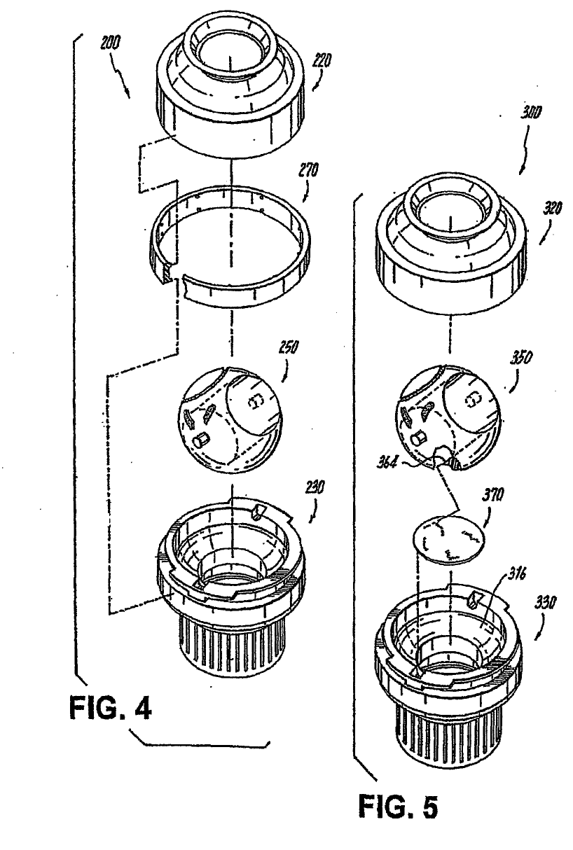

Referring now to FIG. 4, there is illustrated an alternative embodiment of the valve assembly of the present invention designated generally by reference numeral 200. Valve 200 is similar in structure and operation to valve assembly 100. However, unlike valve assembly 100, valve assembly 200 includes a frangible ring 270 which is adapted to be engaged with the housing (i.e., the upper and lower body portions 220, 230) of the valve assembly 200. The frangible ring 270 has been added to valve assembly 200 to provide a visual indication of whether the valve has been previously opened. Frangible ring 270 is molded around the upper and lower body portions 220, 230 of the housing so that when the body portions are rotated relative to each of the the ring 270 is broken. Such a tamper-proof feature would be useful in applications where the valve is with consumer beverages, for example.

Referring now to FIG. 5 which illustrates a further embodiment of the valve assembly of the present invention that has been designated by reference number 300. Valve 300 is similar in structure and operation to valve assembly 100. However, unlike valve 100, valve 300 includes a frangible sealing disc 370 which is positioned within the interior chamber 316 defined in part by the lower body portion of the housing. Frangible sealing disc 370 can function as a tamper-proof feature, as well as, provide an additional seal for valve assembly 300. In this embodiment, the valve member 350 has a shape protuberance 364 formed on its exterior surface. When the valve member 350 is rotated from the open to the closed position the protuberance 364 punctures the sealing disc 370 allowing fluid or air to flow through the valve member 350 when it is returned to the closed position.

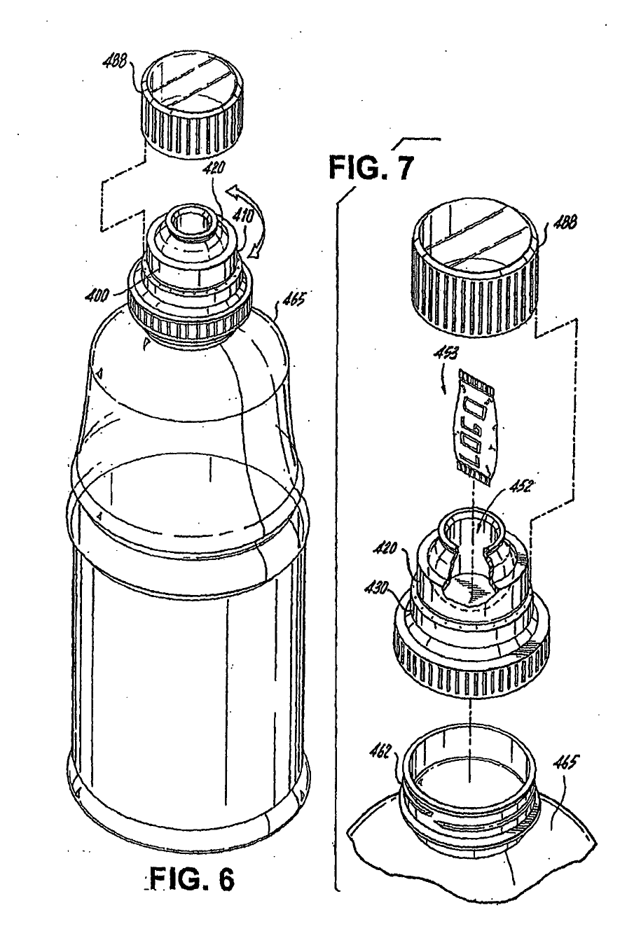

Referring now to FIGS. 6 and 7, which illustrate yet another embodiment of the valve assembly of the present invention designated generally by reference numeral 400. Valve assembly 400 is similar in structure and operation to valve assembly 100. As shown in these figures, valve assembly 400 is threadably engaged with the neck 462 of container 465. A cap 488 is provided which engages with the upper portion 420 of the valve assembly 400. Like the previously disclosed valve assemblies, valve member 450 has a axial bore 452 formed therein which allows fluid or air to flow through the valve assembly 400 when the valve member 450 is in the open position. Still further, the axial bore 452 is adapted for receiving and storing an article of manufacture 453 or fluid, such as for example, a prize, a ticket, a vitamin supplement, or a medication. In such embodiments, it would be advantageous to insert a sealing disc into the valve assembly similar that disclosed with reference to FIG. 5 to prevent to article of manufacture from falling into the container during storage. Alternatively, a removable seal can be placed over the mouth of container 462.

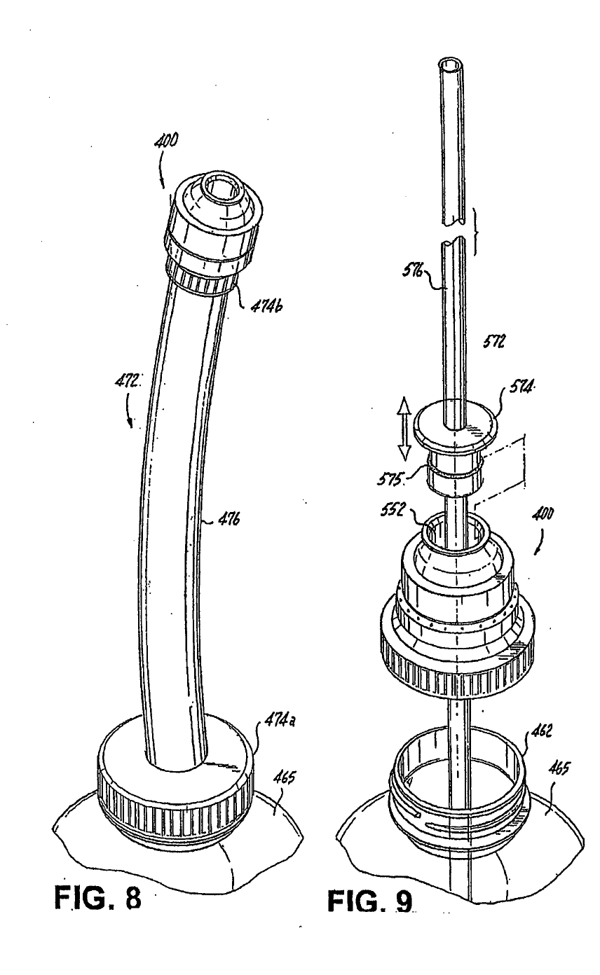

Referring now to FIGS. 8 and 9 which illustrate an alternate application for valve 400. In FIG. 8, valve 400 is mounted on the end of a tubing assembly 472. Tubing assembly 472 includes two end connectors 474a, 474b and an elongated tube 476. End connector 474a is threadably engaged with the neck of container 465 and includes a central aperture which is adapted to allow tube 476 to telescope in and out of container 465. Valve assembly 400 is engaged with end connector 474b such that when the valve is in the open position, fluid can flow from the container 465 through the tubing assembly 472 and out of the valve 400.

FIG. 9 illustrates valve assembly 400 mounted on the neck 462 of container 465. Valve assembly 400 is shown in the open position having straw assembly 572 inserted into the axial bore 552. Straw assembly 572 includes a straw 576 and a plug member 574. The plug member 574 has a circumferential O-ring 575 and is adapted for sealing engagement with the inlet port of valve 400.

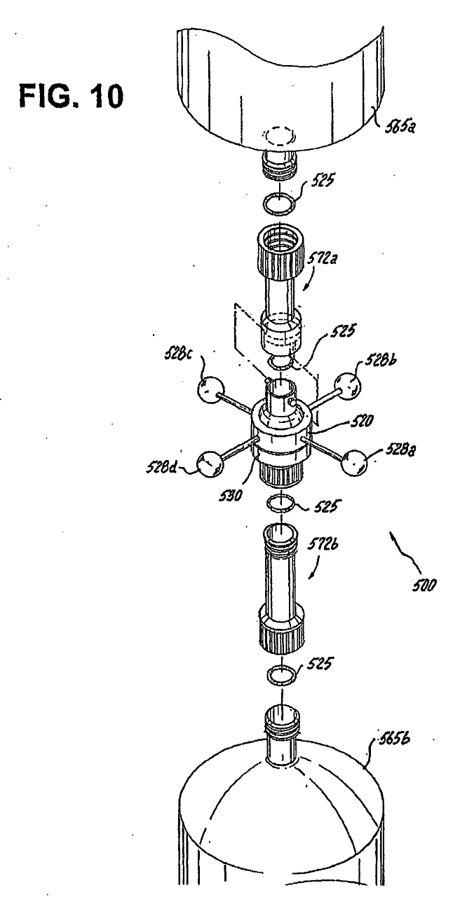

Referring now to FIG. 10, which illustrates a further embodiment of the valve assembly of the present invention, designated generally by reference numeral 500. As shown herein, valve assembly 500 is being used to meter the flow between two containers 565a, 565b. The flow path between the containers includes upper and lower conduit assemblies 572a, 572b and valve assembly 500. The conduit assemblies are sealingly engaged between containers 565a, 565b and the valve assembly 500.

Valve assembly 500 is similar in structure and function to valve assembly 100. However, unlike valve assembly 100, valve assembly 500 includes actuator arms 528a through 528d that facilitate the relative rotation of the upper body portion 520 of the valve assembly 500 with respect to the lower body portion 530 thereby moving the valve member between the open and closed positions. O-rings 525 are provided to seal the connections of the components and prevent leakage from the flow path.

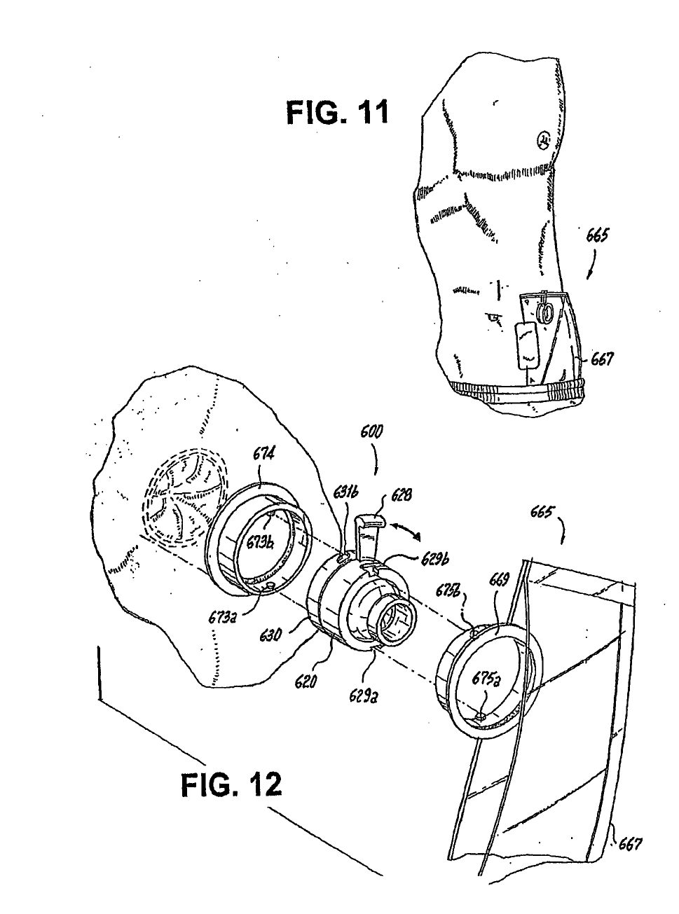

Referring now to FIGS. 11 and 12, wherein valve assembly 600 is shown used in conjunction with a colostomy bag assembly 665. Colostomy bag assembly 665 includes a bag 667, a proximal ring 669 and a distal ring 671. The proximal ring 669 has an outer flange that is sealingly engaged with the bag 667. Two retaining pins 675a, 675b are formed on the inside diameter of the proximal ring 669. These pins 675a, 675b are inserted into corresponding engagement recesses 629a, 629b formed in valve assembly 600 and secure the valve assembly 600 to the proximal ring 669. Similarly, distal ring 671, which is secured to the surface of the patient's body, includes retaining pins 673a, 673b that are inserted into corresponding engagement recesses 631a (not show), 631b formed in valve assembly 600. Valve assembly 600 has been equipped with an actuator arm 628 which allows the patient to move the valve between the open and the closed position as desired.

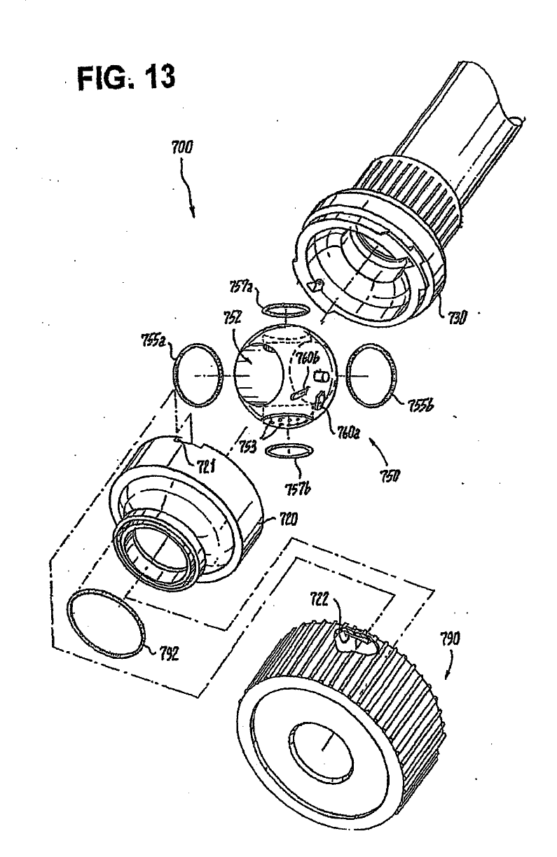

Referring now to FIG. 13, there is illustrated showerhead which includes a valve assembly constructed in accordance with an alternative embodiment of the present invention and designated by reference numeral 700. Again, valve assembly 700 is similar in structure and operation to the previously disclosed valves, but unlike the prior valves, valve assembly 700 has a plurality of flow passages 753 formed in the valve member 750.

The flow passages 753 extend along an axis that is perpendicular to the axial bore 752 such that when the valve member is in the closed position, fluid traverses the valve through the plurality of flow passages 753. Hence when the valve assembly 700 is in the open position, a single jet of water is emitted from the showerhead assembly and when it is in the closed position, water streams from the flow passages 753. O-ring seals 755a, 755b and 757a, 757b are provided at both ends of the axial bore 752 and flow passages 753 to properly seal the valve when in the open and closed positions, respectively.

The showerhead disclosed in FIG. 13 is also equipped with a control ring 790 that sealingly engages with the upper portion 720 of the valve assembly 700 using O-ring seal 792. Control ring 790 has a drive pin 722 formed on its interior surface. Drive pin 722 projects through the slot 721 formed in the upper portion 720 of the valve assembly 700 and engages with the cam lobes 760a, 760b formed the valve member 750. Thus, rotation of the control ring 790 with respect to the lower body portion 730 of the valve assembly 700 moves the valve member between the open and the closed positions.

Those skilled in the art will readily appreciate that the showerhead assembly described hereinabove can be adapted for use for metering an air supply rather than fluid.

Referring now to FIG. 14 which illustrates a valve assembly (designated by reference numeral 800) constructed in accordance with the present invention positioned within the inlet 862 of fuel tank. The use of valve assembly 800 in this application allows for the elimination of a removable gas cap and only requires an approximately 67 degrees rotation of drive ring 890 to open the valve. The axial bore 852 of the valve member would be adapted for receiving a standard fuel pump nozzle 855.

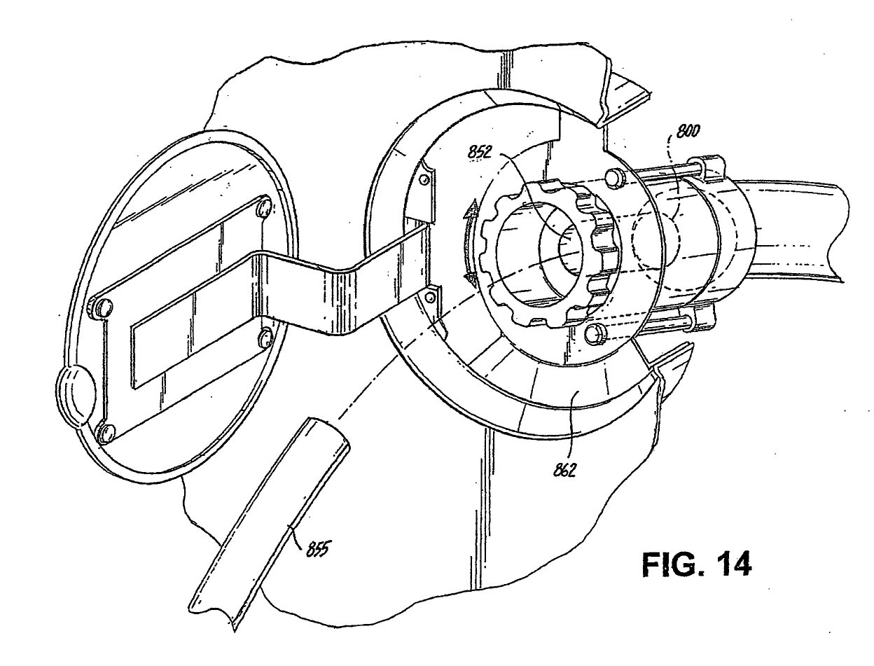

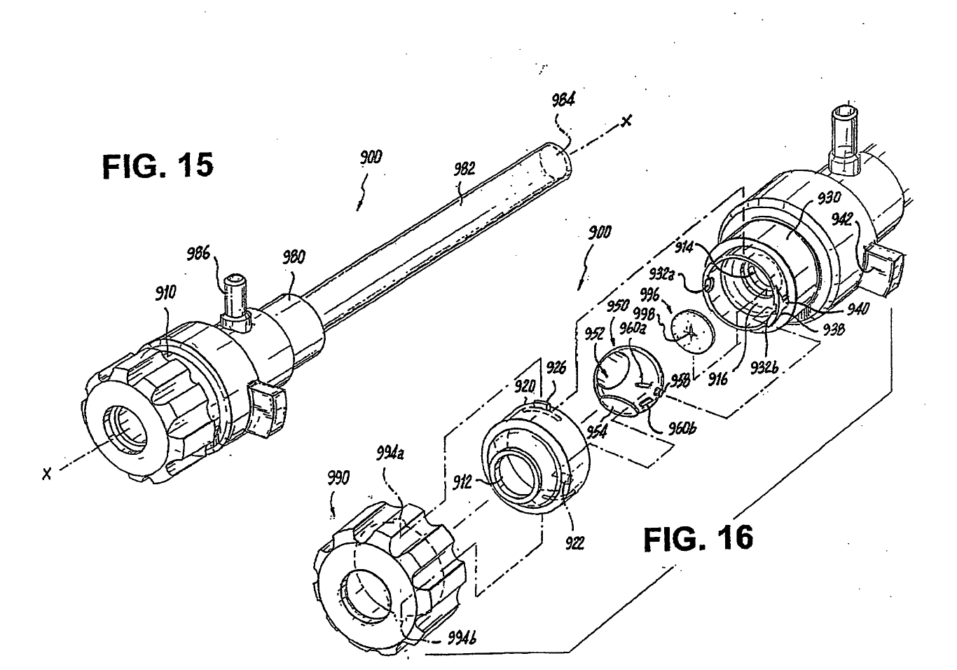

Referring now to FIGS. 15 and 16, there is illustrated a surgical instrument constructed in accordance with a preferred embodiment of the subject invention and designated generally by reference numeral 900.

Minimally invasive surgical procedures are commonly performed by passing surgical instruments through a narrow tube or cannula inserted through a small entrance incision formed in a patient's body using a trocar or obturator. For example, laparoscopic surgical procedures are performed within the abdominal cavity through small incisions formed in the abdominal wall. During a laparoscopic procedure, insufflating gases are introduced into the abdominal cavity to raise the abdominal wall or peritoneum away from the vital organs within the abdominal cavity, thereby providing an adequate region in which to operate.

During a laparoscopic procedure, it is necessary to maintain the atmospheric integrity of the abdominal cavity, and thus prohibit the egress of insufflation gases for the surgical site. It is common therefore, to provide a seal assembly within the cannula so that when instruments are present within the cannula and when instruments are withdrawn form the cannula, the tubular passageway extending therethrough is tightly sealed to prevent the egress of insufflating gases. For example, it is known to employ an elastomeric seal member with an aperture or slit that may be forced open when the instrument is passed therethrough. The seal member prevents the egress of insufflation gasses when the instrument is present and absent from the cannula. There are known disadvantages to employing such seals. In particular, the opening or slit can tear when an instrument is forced therethrough, thus rendering the seal in effective to prevent the egress of insufflating gases from the cannula sleeve.

Therefore as will be described hereinbelow, surgical instrument 900 has been equipped with the valve assembly of the present invention to prevent the egress of insufflating gases through the cannula in the absence of a surgical instrument. Surgical instrument 900 is intended for use as an access device, and more particularly, as a device to facilitate the introduction of a surgical instrument into a person's body during a minimally invasive surgical procedure. Surgical instruments introduced into a patient's body through the surgical instrument 900 of the subject invention can include for example, clip appliers, graspers, dissectors, retractors, staplers, laser fibers, photographic devices, endoscopes, laparoscopes, tubes; and the like.

Surgical instrument or access device 900 includes a proximal valve housing 910 having an inlet port 912 for receiving surgical instruments. Valve housing 910 includes an upper body portion 920 and a lower body portion 930 which define, among other things, a generally hemispherical internal chamber 916 for accommodating a generally spherical valve member 950. Internal chamber 916 communicates with an outlet port 914 of the valve housing 910 which is axially aligned with the inlet port 912. Valve housing 910 is operatively associated with a lower cannula housing 980. Preferably, the valve housing 910 and cannula housing 980 are formed of a polycarbonate material.

An elongated cannula sleeve 982 extends distally from the cannula housing 980. Cannula sleeve 982 has an elongated passageway 984 extending therethrough, which defines a longitudinal axis defined by reference character “X”. Passageway 984 is axially aligned with the inlet port 912 and outlet port 914 of valve housing 910. Cannula sleeve 982 may be formed of stainless steel or another suitable rigid material such as polycarbonate materials or the like. An inlet conduit 986 is incorporated into cannula housing 980 to permit the passage of insufflation gases through the cannula sleeve 982 and into the patient's body cavity. The inlet conduit 986 can include a stopcock valve, which is not shown.

Valve member 950, which is preferably formed from a polycarbonate material, is mounted for axial rotation within the interior chamber 916 about an axis extending perpendicular to the longitudinal axis of the cannula sleeve 982. Diametrically opposed pivot pins 958 (only one pin is shown in FIG. 16) extend radially outwardly from the surface of valve member 950 for accommodation within diametrically opposed recesses 932a, 932b to facilitate the axial rotation of valve member 950. An axial bore 952 extends through the valve member 950, and a convex sealing surface 954 is provided on valve member 950, spaced from axial bore 952.

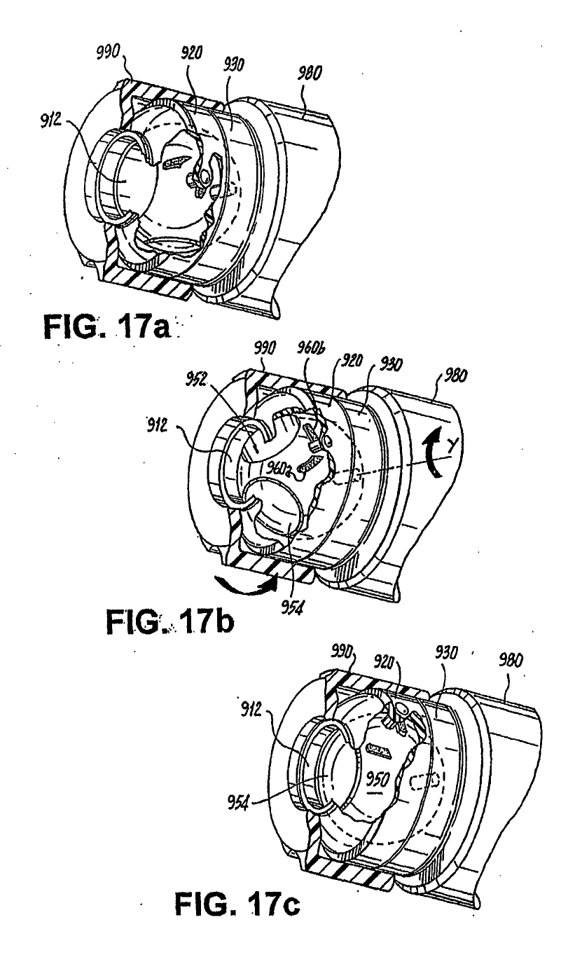

Valve member 950 is mounted for movement between an open position and a closed position. In the open position of valve member 950, which is shown in FIG. 17a the axial bore 952 is axially aligned with the elongated passageway 984 of cannula sleeve 982 and the inlet and outlet ports 912, 914 of valve housing 910. In the closed position of valve member 950, which is shown in FIG. 17c, the axial bore 952 extends perpendicular to the elongated passageway 984 of cannula sleeve 982 and the sealing surface 954 is axially aligned with the inlet port 912 of valve housing 910.

As described with respect to previous embodiments, a camming mechanism is operatively associated with the valve housing 910 and the valve member 950 for moving the valve member 950 between the open position of FIG. 17a and the closed position of FIG. 17c. The camming mechanism includes arcuate cam lobes 960a, 960b formed on the exterior surface of the valve member 950 and a cam pin 922 which extends radially inwardly from the interior surface of the upper housing portion/drive ring 920 to cooperate with the cam lobes. As before, a leading edge of the cam lobes 960a, 960b interacts with the cam pin 922. This interaction facilitates movement of the valve member 950 when the drive ring 920 is rotated about the longitudinal axis “X” of cannula sleeve 982. When the valve member 950 is moved between the open and closed positions, it is rotated about the pivot axis “Y” which extends through the pivot pin 958 of valve member 950, as illustrated in FIG. 3b.

Drive ring 920 is rotatably mounted on the proximal end of valve housing 910 and includes diametrically opposed radially inwardly extending guide ribs 924 which cooperate with an annular guide surface 938 formed on the exterior of the lower body portion 930 of the valve housing 910. Stop surfaces 940 limit the rotational motion of upper body portion/drive ring 920 relative to the longitudinal axis of the cannula sleeve 982.

A fluted manipulation knob 990 is cooperatively engaged with the drive ring 920. Manipulation knob 990 includes inlet port 992, which is aligned with the axial passageway 984 of cannula sleeve 982 and defines in part the inlet port 912 of valve housing 910. The engagement of drive ring 920 and manipulation knob 990 is accomplished through the coupling of a pair of diametrically opposed radially outwardly extending engagement tabs 926 on drive ring 920 (only one tab is shown in FIG. 16) with a pair of corresponding diametrically opposed interior recess 994a, 994b formed in the interior cavity of manipulation knob 990. Alternative structural means may be provided to enable ready manipulation of drive ring 920.

A flange 942 projects radially outwardly from the lower portion 930 of valve housing 910 to provide leverage to the surgeon when the manipulation knob 990 is rotated. Valve housing 910 further includes a membrane seal 996 located proximal to the interior chamber 916 and retained within an annular recess. Membrane seal 996 has a central slitted opening 998 that is axially aligned with the outlet port 912 of valve housing 910 and the passageway 984 of the cannula sleeve 982. Central opening 998 is dimensioned and configured to accommodate the passage of a surgical instrument therethrough. The membrane seal 996 will help to prevent the egress of insufflation gasses from the access device 900 when an instrument is present therein and the valve member 950 is in an open position.

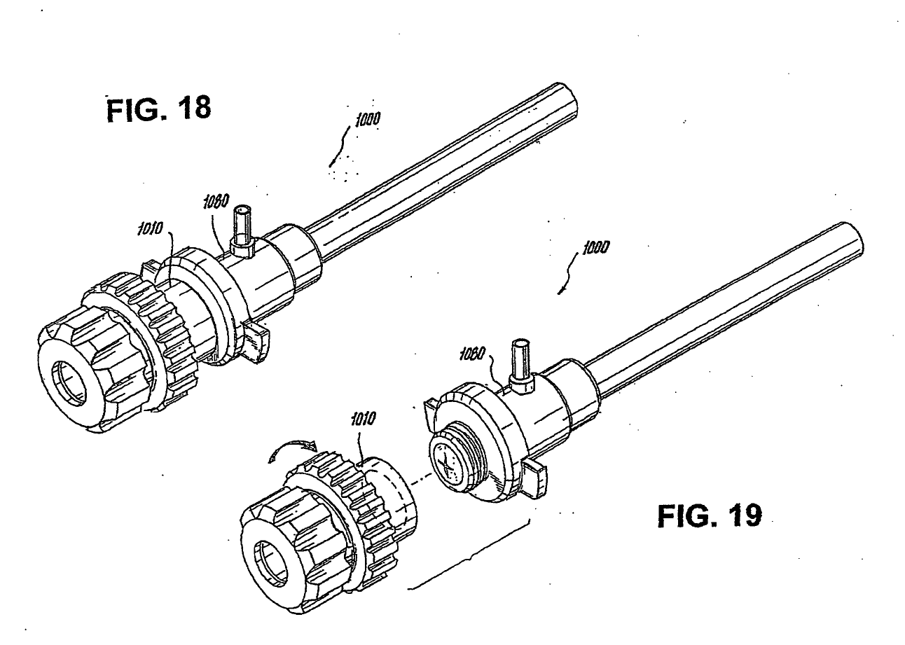

Referring now to FIGS. 18 and 19, there is a perspective view of another embodiment of the surgical access device of the subject invention, which is designated by reference numeral 1000 and includes a detachable valve housing 1010. More particularly, as best seen in FIG. 5. The valve housing 1010 is detachably connected to the cannula housing 1080. This will enable a surgeon to utilize the cannula housing 1080 during the performance of procedures in which the valve housing is not required. It will also enable the surgeon to readily remove specimens from the surgical site. As illustrated, the detachable relationship of valve housing 1010 and cannula housing 1080 is facilitated by a threaded connection therebetween. Alternative coupling arrangements are envisioned and well within the scope of the subject disclosure.

Although the valve assembly of the subject invention and surgical access device incorporating the same have been described with respect to preferred embodiments, those skilled in the art will readily appreciate that changes and modifications may be made thereto without departing from the spirit and scope of the subject invention as defined by the appended claims.

Additionally, the valve assembly of the subject invention can be used in alternative applications not described hereinabove. For example, the valve can be installed in a sink drain to eliminate the need for a plug. Additionally, the valve can replace bungs or plugs used to seal penetrations in the hull of boats. Still further, the valve can replace caps on hand creams, toothpaste, etc.

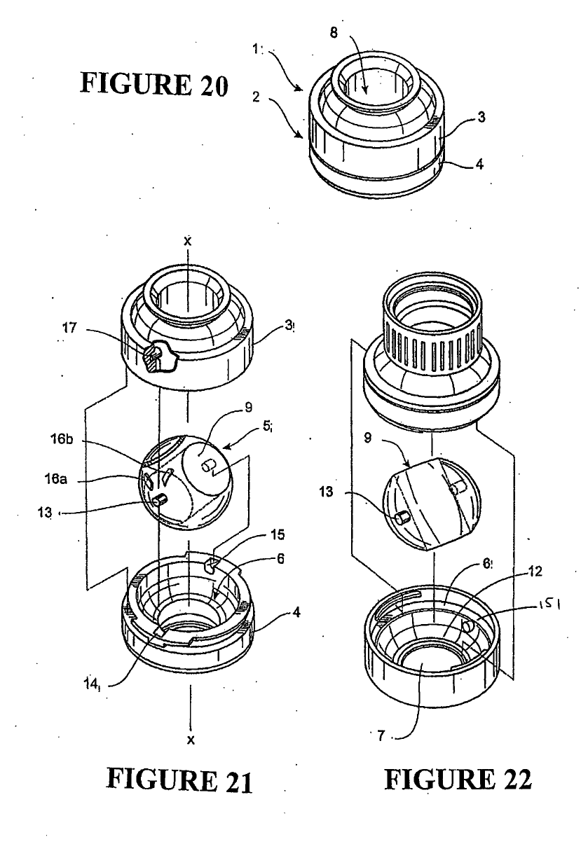

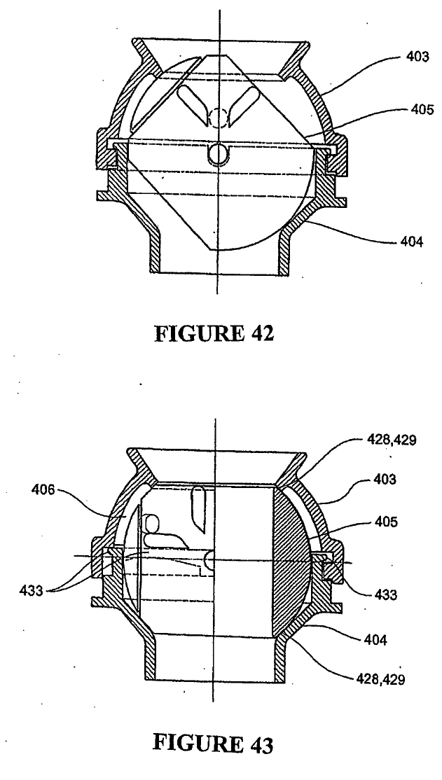

Referring now to FIGS. 20-51, the drawings wherein like reference numerals identify similar structural elements or features of the subject invention, there is illustrated in FIG. 20 a flow switch or valve assembly 1 of prior art as found in our PCT Application WO2004/106782. More detail of the valve mechanism operation are described in WO2004/106782 which is hereby incorporated by way of reference. Various flow switch assemblies of the present invention define variations from the prior art. The variations are preferably for use in consumer beverage applications however alternative applications such as but not limited to plumbing or hydraulics, may also be mentioned or be apparent. Where reference herein is made to fluid or fluid flow or fluid communication it should also be appreciated that this could also be reference to solid or particulate materials.

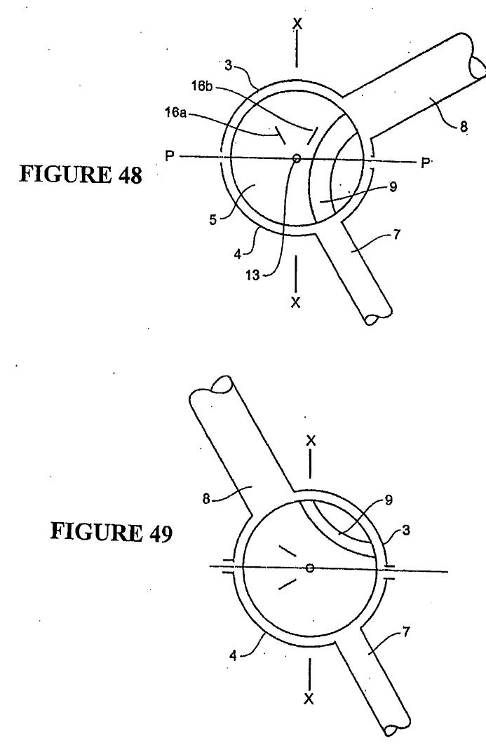

The flow switch assembly 1 includes, inter alia, a valve housing 2 having an upper body portion 3 and a lower body portion 4 and a valve member 5 preferably of a spherical shape. The upper and lower body portions 3,5 of the housing 2 define an internal cavity 6 to capture the valve member 5. The flow switch assembly may have a central axis “X”. The housing 2 preferably also has inlet and outlet ports 7 and 8 respectively, formed in the lower and upper body portions 4 and 3 respectively. These are diametrically opposed on each side of the valve member 5, but with respect to the present invention this axial alignment need not necessarily be so (see for example, FIGS. 48 and 49 for an illustration of alternatives).

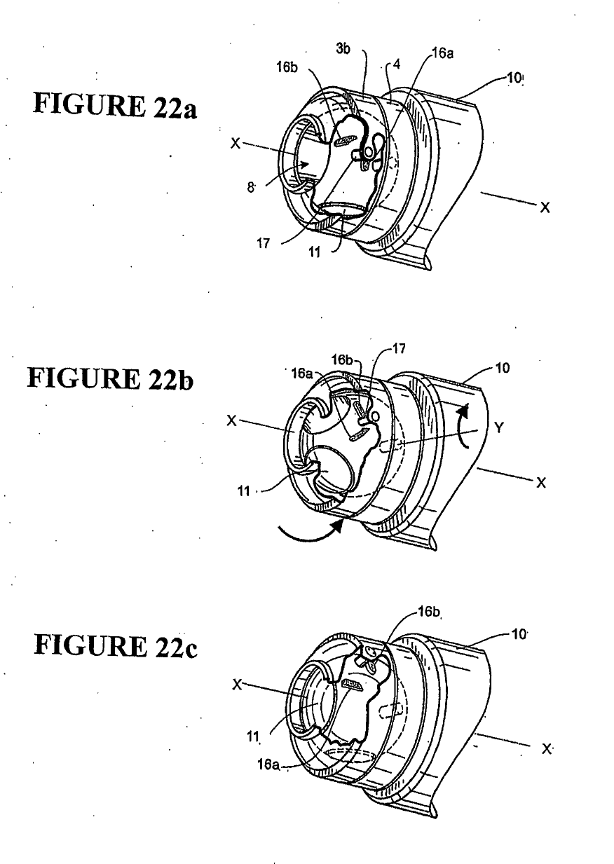

The valve member 5 is seated within the internal cavity 6 of the valve housing 2 and has a passage 9 extending therethrough. The valve member 5 is mounted for movement within the internal cavity 6 of the housing 2 between an open position and a closed position. FIG. 22A illustrates flow switch assembly 1 in the open position; wherein the passage 9 of the valve member 5 allows fluid communication between the inlet port 7 and the outlet port 8 of the valve housing 2. In a like manner, FIG. 22C illustrates the flow switch assembly 1 in the closed position; wherein the passage 9 of the valve member 5 is positioned relative to the inlet and outlet ports 7/8 of the valve housing 2 to prevent flow of fluid between the ports. FIG. 22B, shows detail of the valve assembly 1 in an intermediate position.

Valve member 5 (which is preferably spherical in shape but could be slightly non-spherical) moves between the open position and the closed position when the upper body portion 3 of the housing is rotated about the central axis “X” with respect to the lower body portion 4. The valve member 5 is mounted for rotation within the interior chamber about an axis “Y” (see FIG. 22B) extending preferably perpendicular to the central axis “X” defined by the upper and lower body portions 3, 4 of the valve housing 2. The chamber need not be one that fully encloses the valve but could be one where the valve is at least partially exposed to the outside.

The valve member 5 may include a sealing surface 11 that is adapted for sealing engagement with annular valve seat 12 formed in the housing 2 when the valve is in a closed position.

Two, preferably diametrically opposed, pivot pins 13 (only one pin is shown in FIG. 21) extend radially outwardly from the surface of the valve member 5 for accommodation within diametrically opposed recesses 14 and formed in a lower body portion 4 of the housing 2 to facilitate the rotation of the valve member 5. This configuration may be reversed where the recesses are of the upper body portion and cam pin as will be described later, is on the lower body portion.

A camming or driving mechanism is operatively associated with the valve housing 2 and the valve member 5 for moving the valve member 5 between the open position of FIG. 22A and the closed position of FIG. 22C. The camming mechanism may include cam lobes 16A, 16B (protrusion or projection from the valve element 5 or recesses (such as a scallop) into the valve element 5) formed at the exterior surface of the valve member 5 and a cam pin that extends inwardly (preferably radially inwardly) from the interior surface of the upper body portion 3 of the housing 2 to cooperate with the cam lobes. The interaction therebetween allows for movement of the valve member between open and closed conditions upon relative rotation of the upper and lower body portions.

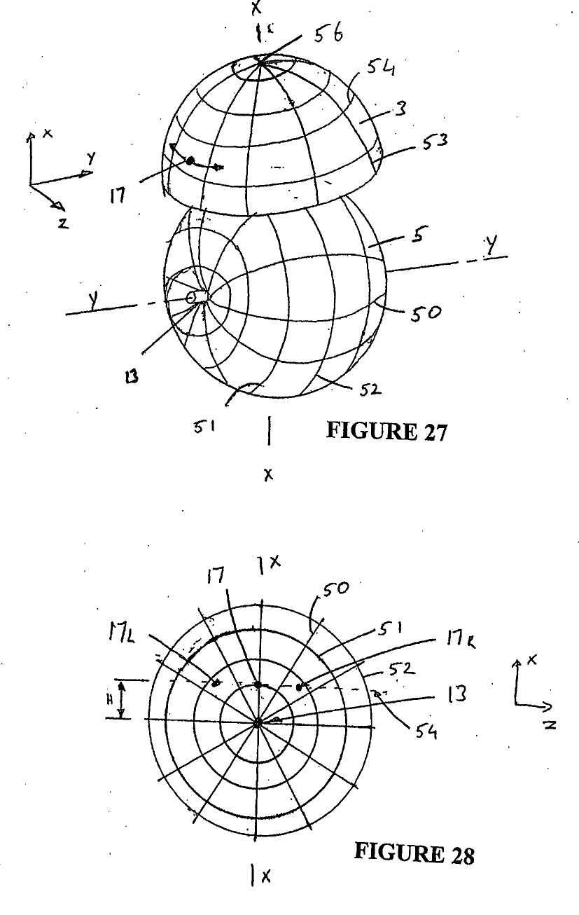

With reference to FIG. 27 there is shown a reference to the valve assembly including the valve member 5 rotating about the axis YY supported by the pivot pins 13. Drawn on the spherical valve member 5, are lines of longitude 50 that extend between the poles at the pivot pins 13. The sphere also includes lines of latitude 51 including the equator line 52 midway between the opposed poles.

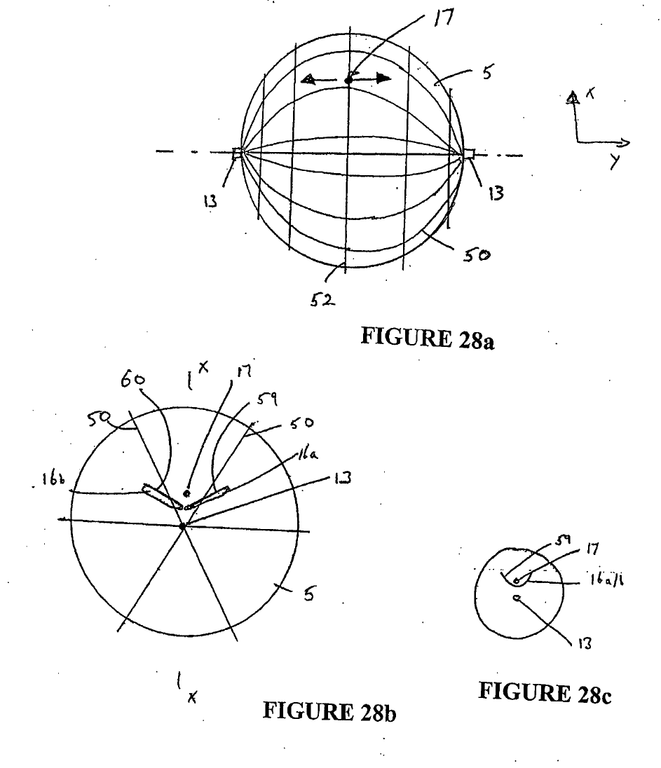

As also shown in FIG. 27 is an upper body portion 3 that is shown in an exploded view relative the valve member 5 and wherein it is positioned for rotation about the axis XX. Shown on the upper body portion 3 are its lines of longitude 53 and its lines of latitude 54. Also shown is the cam pin 17 mounted by the upper body portion 3 and mounted for movement parallel to the latitudinal lines 54. In the preferred form where the XX and YY axes are perpendicular to each other, the lines of latitude 54 of the upper body portion 3 lie parallel to the YY axis. Likewise the lines of latitude 51 of the valve member 5 lie parallel to the X axis. Positioning of the cam pin 17 of the upper body portion 3 is preferably such that it is located proximate the axis YY and proximate the poles at pivot pins 13. Interaction of the cam pin with the cam lobes at this region results in favorable mechanical advantage to be provided during the rotation of the upper body portion 3 about the axis XX with the valve member 5. With reference to FIG. 28, it can be seen that a movement of the cam pin 17 along a latitudinal line or plane of the upper body portion 3 between its left most limit of movement at 17L and its right most limit of movement at 17R results in the cam pin 17 traversing across a higher density of longitudinal lines 50 of the valve member 5. In other words, for the same arc traveled by the pin 17 along one of its latitudinal lines the pin will cross more lines of longitude at this more preferred location of the pin, than at an arc that is further from the pole 13 towards the equator 52. Also the further the cam pin 17 is positioned towards the pole 56 of the upper body portion 3, the less the mechanical advantage will become. In the preferred form the cam pin 17 has its limits of movement provided on either side of the plane sitting in the X-X and Y-Y axes (i.e. the XY plane).

FIG. 28a illustrates a positioning of the cam pin 17 in a undesirable position. Referring to FIGS. 28 and 28a in this position the cam pin is located proximate the equator 52 of the valve member 5 and moves parallel to the YZ plane (i.e. in a latitudinal line 54 of the upper body portion 3 but only on one side of the XY plane of the valve housing 5). Such positioning of the cam pin is undesirable as it does not traverse a high density of longitudinal lines 50 of the valve member 5 to effect favorable mechanical advantage. Other inherent problems may also arise.

Although not shown in FIGS. 27 and 28, the cam lobes present a reaction surface that may each extend parallel a line of longitude 50 of the valve member. However alternatively the reaction surface may traverse across the line of longitude of the valve member 5. The reaction surface of a cam lobe need not be a straight surface but may be curved yet still allow for the cam pin 17 to react therewith for the purposes of displacing and rotating the valve member 5 about the YY axis. Such a variation is for example shown with reference to FIG. 28b, where the cam lobes 16a and 16b have reaction surfaces 59 and 60 respectively that each traverse a respective line of longitude 50 of the valve member 5.

Whilst reference herein is made to longitudinal and latitudinal lines having direct reference to a spherical valve element, it will be appreciated that other forms of valve elements will have similar principles at work given that such will still have two poles.

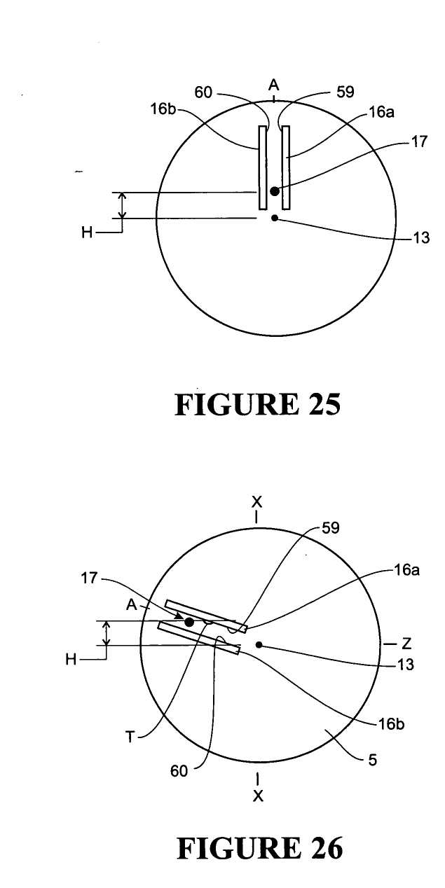

A further variation to the cam lobes is shown with reference to FIGS. 25 and 26 wherein the reaction surfaces 59 and 60 are parallel each other and intermediate of which the cam pin 17 is placed. FIG. 26 illustrates the cam pin 17 being displaced to the left side of the XY plane thereby having rotated the valve member 5 in a anticlockwise direction about the YY axis. The reaction surface 60 of the cam lobe 16b has been interacted with by the cam pin 17 in rotating the valve in the anticlockwise direction. Rotation of the cam pin 17 about the XX axis in the opposite direction will result in a returning of the valve member 5 to the position shown in FIG. 25. The return rotation will result in the cam pin 17 engaging with the reaction surface 59 of the cam lobe 16a. A close positioning of the two reaction surfaces 59 and 60 when the cam pin is at its extremes of rotation, will result in little or no play existing between the interaction of the cam pin 17 with the reaction surfaces 60 and 59. Such play can be minimized by a positioning of the cam pin 17 proximate more the pivot pins 13 where for example the cam lobes are in a V-shaped configuration. They may also be of a U-shaped configuration. The reaction surfaces are preferably straight when locking onto the valve but they may also be curved other than being curved to follow the surface of the preferred spherical valve member. Alternatively, an appropriate positioning of the V-shaped cam lobes such that their reaction surfaces traverse across the lines of longitude 50 or by having cam lobes that are of or tend towards a parallel configuration as shown in FIGS. 25 and 26 may have similar effect.

However one of the potential disadvantages of parallel cam lobes as shown in FIGS. 25 and 26 is for example with reference to FIG. 26. Upon the return of the cam pin 17 to rotate the valve member 5 in a clockwise direction, the angle of incidence of the movement of the cam pin 17 (parallel to the ZZ plane) with the reaction surface 59, may be an angle that is too shallow and may result in jamming or an un-rotatable valve member. The angle T as shown in FIG. 26 is relatively large and therefore a shallow angle of contact is made between the reaction surface 59 and the cam pin 17 upon the movement of the cam pin 17 to rotate the valve member 5 in the clockwise direction. The further that the angle tends towards 90 degrees or zero degrees and away from 180 degrees, the less likely that such jamming will occur.

A person skilled in the art will realize that variations to this preferred configuration can occur including where the XY plane and the ZY planes are not perpendicular of each other.

The degree of play may be dependent on the degree of separation of the reaction surfaces at the latitude of the upper body portion at where the cam pin is mounted. Where the surfaces are of a V-shaped configuration, the closer that the cam pin is mounted towards the apex of the V, the less play there will be. The apex of the V (whether or not the surfaces in fact touch each other) may be at the pole of the valve member or may terminate at a latitude of the valve member away from the pole.

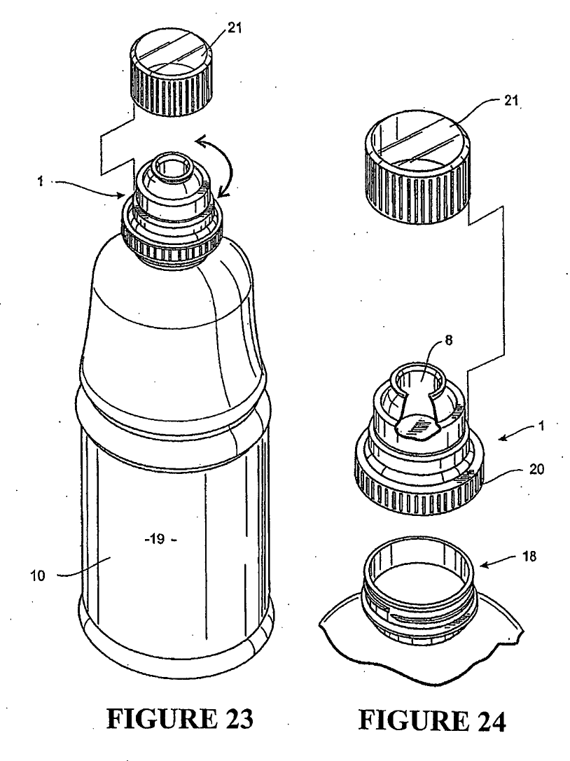

FIGS. 23 and 24 illustrate a flow switch assembly engaged with a beverage container 10. The flow switch assembly 1, can be threadingly engaged to a beverage container 10 as a result of the beverage container providing a threaded spout 18. The spout is for example integrally formed with the container portion 19. The beverage container 10 may be formed using any suitable method including blow or injection molding and may be formed of plastic or any suitable material and may be of a size sufficient to contain beverages such as water or flavored water or soft drink or the like. The container may also include carbonated liquid. The flow switch assembly 1 may include a collar 20 that includes an internal thread that is engageable onto an external thread of the spout 18. A sealing engagement between the valve assembly 1 and the spout 18 can be established so that contents of the beverage container 10 can pass through the spout 18 and through the flow switch assembly 1.

Also shown in FIGS. 23 and 24 is an overcap 21 that can engage over the outlet port 8 of the flow switch assembly 1 so as to conceal both the outlet port 8 and the surrounding external region with which the mouth of a consumer is, in a usual manner of use, engaged. The overcap hence therefore provides hygiene advantages. It may also include tamper evident features. So may the valve assembly.

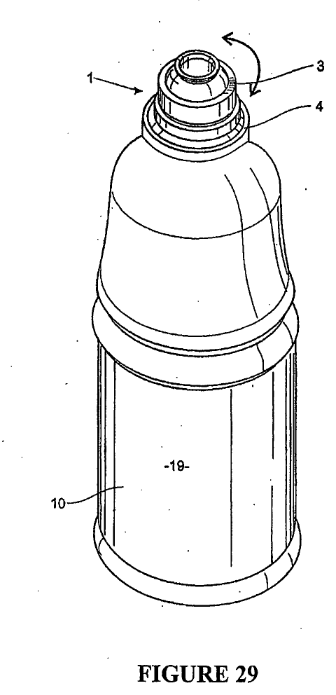

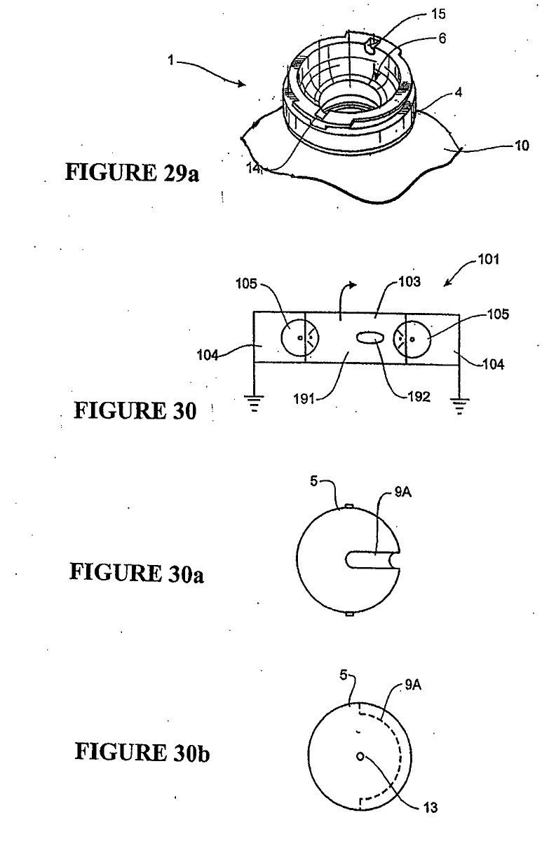

With reference to FIGS. 29 and 29a there is shown improvements to the arrangement of FIGS. 20 to 24. The flow switch assembly 1 as shown in FIG. 29 is in part defined by a portion integrally formed with the beverage container 10. In FIG. 29a the lower body portion 4 of the flow switch assembly is shown integrally formed with the beverage container 10. The lower body portion 4 defines those features that have hereinbefore been described with reference to the flow switch assembly but are provided in a manner integrally formed with a beverage container 10. The upper body portion 3 and valve member 5 can, in a like manner as previously described, engage with the lower body portion 4 as shown in FIG. 29, to define a flow switch assembly 1. Alternative modes of engagement of the lower body position to the container may also be provided. Such may include push fit or adhesive or welded engagement.

The example of FIG. 29 allows for a beverage container incorporating a flow switch assembly 1 to be provided that may utilize less plastics materials and may also be cheaper to produce as a result of fewer assembly steps.

The lower body portion 4 may be defined integrally with the beverage container 10. Various methods of manufacture can be employed. Such may include an injection molding or by a blow molding of such. Whilst the tolerances in blow molding may not be as accurate as in injection molding, the flow switch assembly 1 can be designed so that with lower tolerances, adequate sealing and closure of the flow switch assembly 1 can still be established. The lower body portion 4 need not in fact be of a tolerance to encourage a sealing of the container 10, by the valve member 5. In this regard, sealing may be achieved by the interaction of the valve member 5 with the upper body portion 3. The lower body portion 4 need only be of a tolerance sufficient to cradle the valve member 5 and to provide the recesses 14 and 15 for defining a pivot for the pivot pins 13.

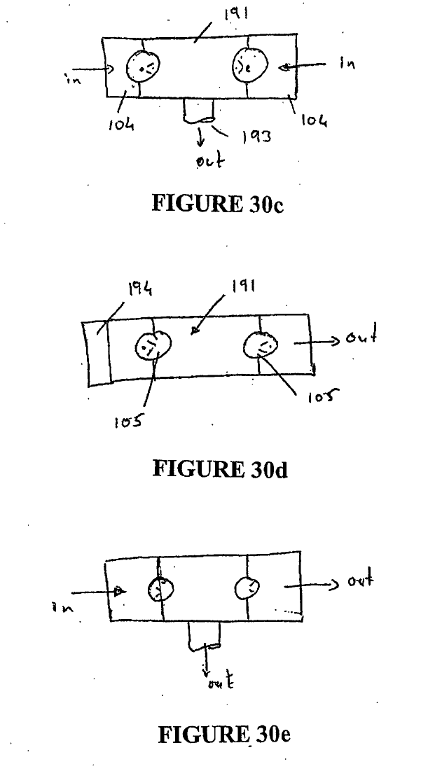

With reference to FIG. 30 there is shown a variation to the flow switch assembly 1. In FIG. 30 there is shown a flow switch assembly 101 wherein there are two valve members 105. Each valve member is mounted by a respective lower body portion 104 and is actuable by camming pins or protrusions mounted from an upper body portion 103. The flow switch assembly 101 of FIG. 30 illustrates a multi valve member assembly that may utilize the basic technology as hereinbefore described. Daisy chaining of a number of valve assemblies as described herein where two or more are engaged together can be employed or used.

In the specific example shown in FIG. 30 the two lower body portions 104 are shown to be fixed whereas the upper body portion 103 is capable of rotation relative to both lower body portions 104. This will allow the movement of the valve members 105 by the relative rotation of the upper body portion 103 relative to the lower body portions 104. The valve members 105 may be provided so that a movement of the upper body portion 103 may simultaneously move both valve members 105. Such movement may open one and close another of the valve members or open and close both simultaneously.

Partial opening and closure may also be a relative positional relationship that can exist between the two valve members. The passage (or opening of the upper/lower body portion) through one of the valve members 105 may be significantly larger than the passage through the other valve member thereby allowing for one of the valve members to remain in an open or closed condition for longer than the other of the valve members during a rotation of the upper body portion 103. Such a configuration can also control different flow rates.

The assembly of FIG. 30 may also include a variation where the lower body portions are rotatable relative to each other and relative to the upper body portion. This will allow for independent control of the two valve members to occur. The assembly of FIG. 30 may have application for drink bottles. The openable cavity 191 provided between the valve members may contain a tablet 192 of some form that, upon the rotation of a valve member disposed between the cavity and the containment region of a bottle, can allow for the tablet to fall into the containment region of the bottle. The tablet 192 may for example be a water treatment tablet to decontaminate the water of undesirable or harmful contaminants. Once the valve member is opened to allow the tablet to drop into the containment region, the upper valve member may then be opened to allow for the contents of the containment region of the drink bottle to be consumed. The tablet may, be a flavoring tablet or a novelty tablet to change the color of the liquid within the containment region of the bottle. The tablet may also be used for the purposes of aerating or effervescing the liquid. The tablet may alternatively be a gel, a capsule, or any other suitable form of additive.

The valve member 105 (or the openings through either or both its related body portions) distal most from the bottle may provide an opening or passage there through that is of a size insufficient to allow a tablet to pass through the passage or opening of the valve 105. Therefore the only way that the tablet can pass is through an opening or passage through the valve 105 proximate most the bottle so as to allow for the displacement of the tablet into the bottle only. This will prevent the removal of the tablet from the cavity or duct 191 and will only allow for the tablet to pass into the container region of the bottle.

FIG. 30c illustrates a variation to that shown in FIG. 30. In FIG. 30c the openable cavity 191 includes an outlet opening 193 that can allow the passing of a fluid or solid that enters the openable cavity 191 from either of the two inlets designated “in” of the lower body portions 104. This variation allows for a flow of fluid and mixing of fluid to occur between the inlet or inlets and the outlet.

With reference to FIG. 30d there is shown a variation to that of FIGS. 30 and 30c wherein an outlet, provided by one of the lower body portions 104, can allow for fluid to be dispensed from the device as shown wherein the fluid may be a mixture of that previously separated and contained in the cavity 191 and in a further cavity 194. An opening of the left more valve assembly 105 may occur allowing for the fluid in the cavities 194 and 191 to mix whereupon after mixing, an opening of the right more valve member 105 allows for the mixture to be dispensed.

With reference to FIG. 30e, there is shown a variation wherein a directional control of flow can be established. Two outlets are provided wherein in a first mode fluid exits only from the lower more outlet as shown and in a second mode fluid through both the outlets as shown.

With reference to FIGS. 30a and 30b there is shown a valve member 5 that where a passage 9a can be defined in part by the slot 9a of the valve member that, in co-operation with the valve housing, can establish a passage between the inlet and outlet of the valve housing. FIGS. 30a and 30b illustrates that it need not be the valve solely that defines the passage but that the passage may be provided in part by the valve and the valve housing.

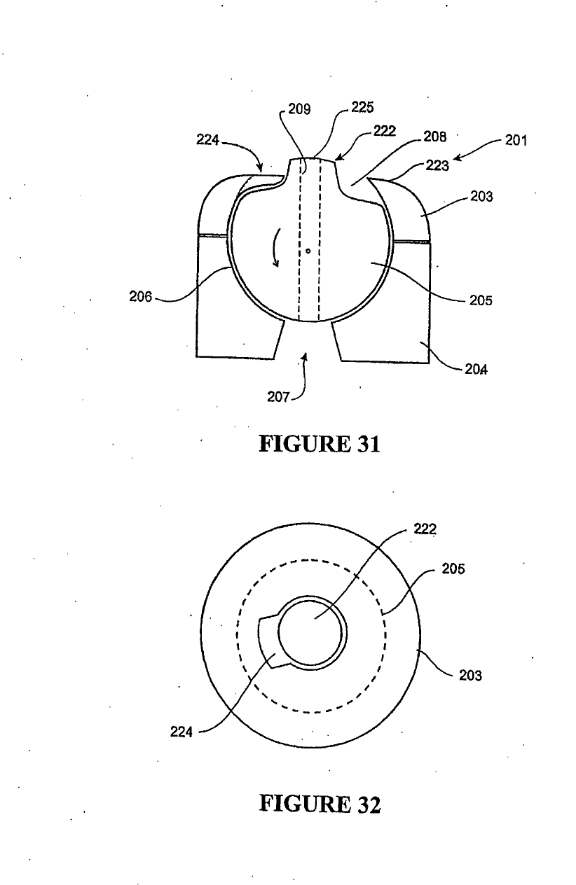

With reference to FIG. 31 there is shown a flow switch assembly 201 that incorporates a valve member 205 that is of a non-spherical shape. The valve member 205 is of a partial spherical shape and includes a spout region 222 provided at the outlet end of the passage 209 of the valve member 205. The spout region 222 is shaped to allow for it to at least in part extend into the mouth of a user. The spout region 222 of the valve member 205 extends beyond the boundary of the upper body portion 203 and can hence be inserted into the mouth of a user.

The spout region 222 is preferably defined by a cutting away of part of an otherwise spherical (or otherwise shaped) valve member 205. The cutaway portions of the valve member 205 allow for a spout region 222 to be defined as part of the valve member 205. The upper body portion 203 may be modified to allow for the spout region 222 to be capable of projecting beyond the upper surface 223 of the upper body portion 203. In a closed condition the valve member 205 is still capable of being rotated to prevent communication between the inlet port 207 and the outlet port 208 of the valve member 205. Indeed in this example the outlet port 208 serves the function to allow for the outlet spout 222 to pass therethrough when the flow switch assembly 201 is in the open condition. In this position, the spout allows fluid communication or fluid passage via said outlet 208 of said upper body portion 203. In this condition, the fluid or solid passage or fluid communication is not strictly between said inlet and outlet of said housing but between the inlet of the housing and the outlet spout, via the outlet of the housing.

The upper body portion 203 may be shaped to include an outlet port 208 that may include a slot or channel 224 via which the spout region 222 of the valve member 205 can pass in moving between the open condition and the closed condition of the flow switch assembly 201. However such a slot or channel 224 need not necessarily be provided and the outlet port 208 may be of a size to accommodate full rotation of a fully spherical valve member 205. When in the closed condition the partially spherical surface 225 of the spout region 222 is still capable of sealing against a complimentary surface of the internal cavity 206 defined by the upper and lower body portions 203 and 204 to close the flow switch.

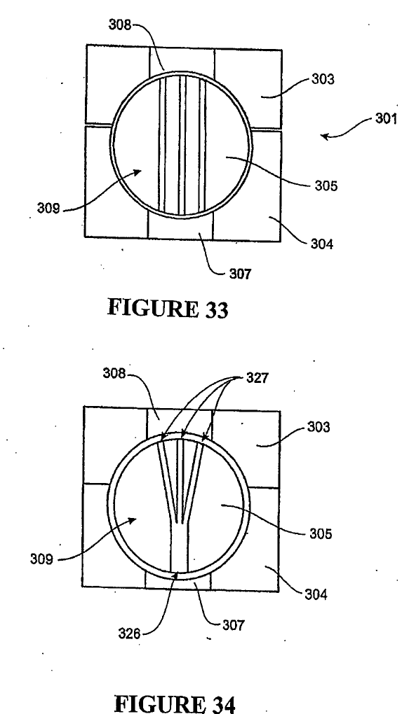

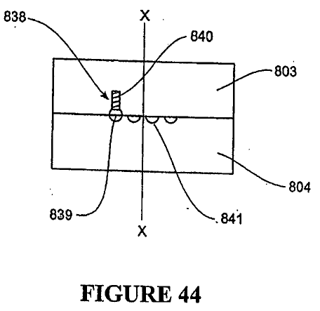

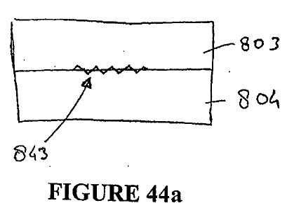

With reference to FIG. 33 there is shown a flow switch assembly 301 wherein the upper and lower body portions 303 and 304 include a single outlet and inlet port 308/307 respectively. In this example the valve member 305 includes a plurality of passages 309. Each such passages are capable of being moved to a position to allow for a fluid communication or flow passage for fluid or solids to be established therethrough. In this configuration it is also possible for some and not all of the passages 309 to establish such fluid communication. This variation of the flow switch assembly 301 will allow for the valve member 305 to accurately establish a variable sized flow path, because the valve member 305 can allow for a variable flow rate to be defined. Where some form of indexing of the relative rotation of the upper body portion and lower body portion 303/304 can be established (and this is hereinafter described by reference to FIG. 44) the flow switch assembly 301 can allow for variable flow path sizes to be established between the inlet and outlet ports 7/8 (307/308).

FIG. 34 shows a variation to the multiple flow path defining valve member 305. In this example a single inlet 326 is provided positioned adjacent the inlet port 307 of the lower body portion 304. A bifurcated passage or a multi passage branching from the inlet 326 of the passage 309 is shown in FIG. 34. Multiple outlets 327 are provided by the valve member 305. The multiple outlets 327 can be presented to the outlet port 308 to establish flow communication between the inlet port 307 and 308. Rotation of the valve member 305 can also allow for variable flow paths and variable flow rates.

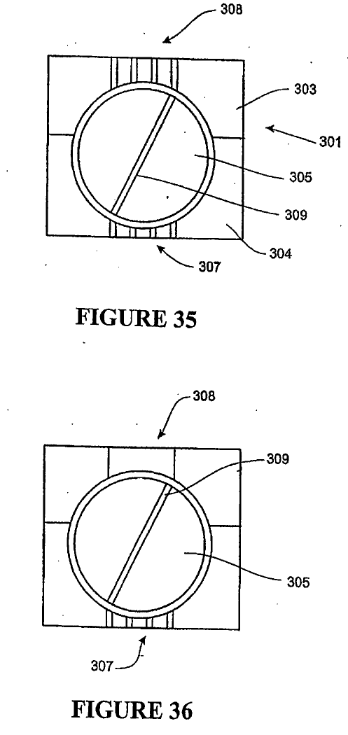

With reference to FIG. 35 there is shown a further variation to the flow switch assembly 301 wherein multiple inlet ports 307 and multiple outlet ports 308 are provided. In the example shown in FIG. 35 a single passage 309 extends through the valve member 305. In this example the flow switch assembly 301 is capable of providing selective fluid communication between different inlet and outlet ports 307/308. This allows for a switching between different channels for, for example, dispensing different fluids or solids or controlling flow such as for hydraulics application. The flow switch assembly of FIG. 35 may for example have application in bars. The flow switch of FIG. 35 will allow for a single drinks dispenser to selectively dispense discrete or a mixture of different beverages. The outlet ports 308 may remain discrete or such may merge into a single conduit for delivery via a single outlet (not shown) for dispensing beverages into a glass. The inlet ports 307 may each individually be in fluid communication with different reservoirs containing different beverages. Indexing as for example hereinafter described between the upper and lower body portions 303 and 304 may be provided to facilitate channel selection.

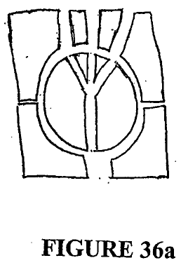

FIG. 36 shows multiple inlet ports 307 and a single outlet port 308 to allow for selective communication to be established between individual inlet ports 307 and the single outlet port 308 by the passage 309 of the valve member 305. A variation to this is where multiple outlet ports may be served by a single inlet port. This has application in flow rate control and/or flow path control.

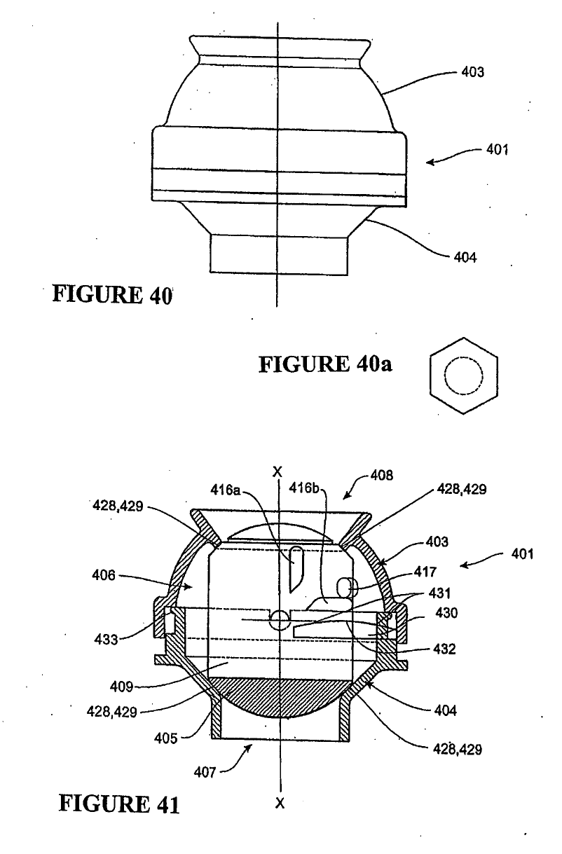

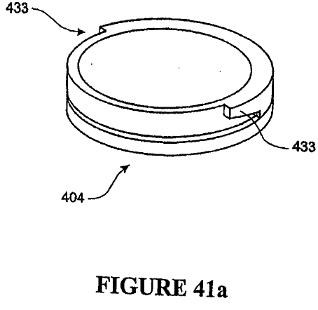

FIG. 40 illustrates a flow switch assembly 401 that includes an upper body portion 403 and a lower body portion 404. With reference to FIG. 41 it can be seen that the flow switch assembly of FIG. 40 also includes a valve member 405 rotatable in a manner as hereinbefore described to allow for fluid communication to be established between the inlet port 407 and 408. In the condition as shown in FIG. 41 the valve assembly 401 is in a closed condition as a result of the passage 409 being out of alignment with at least one and preferably both the inlet and outlet ports 407/408. In this example it can be seen that the internal cavity 406 need not be of a complimentary shape to the shape of the valve member 405. It can also be seen that the valve member 405 need not be completely spherical.

The valve member 405 includes sealing surfaces 428 that are capable of seating with respective seating surfaces 429 of one or both of the upper and lower body portions 403 and 404. Such seating occurs when the valve member is in a condition to define a valve assembly in a closed condition as shown in FIG. 41 and preferably also when in an open condition as shown in FIG. 43. However in the open condition as shown in FIG. 43, such seating of the sealing surfaces 428 with the seating 429 need not necessarily occur. Some fluid may in such a condition also pass through or displace into the internal cavity 406.

The flow switch assembly 401 shown in FIGS. 40-43 includes a feature that enables a clamped sealing of the valve sealing surfaces 428 and the valve seating surfaces 429 to be established. With reference to FIG. 41 it can be seen that the upper body portion 403 includes a ramped or wedge shaped cam member 430. The wedge 430 is rotatable with the upper body portion 403. The wedge 430 includes ramped surfaces 431 on both sides of its apex 432. The ramped surfaces extend outwardly from the apex 432 in a direction tangential or on the arc of a radius about the rotational axis XX of the upper and lower body portions 403 and 404. The ramped surfaces are of a camming nature provided to interact with a cam follower 433 provided by the lower body portion 404. In the example shown in FIG. 41-43 the cam follower may be part of the lower body portion and positioned to allow interaction with the ramped surfaces at certain angular positions of the upper and lower body portions.

The ramped surfaces 431 interact with the cam follower 433 at points of relative rotation between the upper and lower body portions when the valve member is at and immediately prior to both or one of the open and closed conditions. The interaction between the ramped surfaces and the cam follower is such that when sealing between the sealing surfaces 428 and the seating surfaces 429 is required (i.e. when the valve assembly is in a closed condition and preferably also when it is in the open condition), the ramped surfaces encourage a displacement in or parallel to the axial direction XX of the upper and lower body portions to bring these together.

The bringing together of the upper and lower body portions as a result of the interaction between the ramped surfaces and the cam follower will result in a pressing of the seating surfaces 429 onto the sealing surfaces 428. Such a clamping or pressing results in a better seal being established between the sealing surfaces 428 and seating surfaces 429. The relative tangential positioning of the ramped surfaces and cam follower or followers of the upper and lower body portions respectively, will allow for such a clamping to be established at the appropriate points of relative rotation between the upper and lower body portions corresponding to appropriate angular positions of the valve member.

Whilst the wedge 430 may include two ramp surfaces, one on each side of the apex 432, it will be appreciated that the wedge may only include one ramped surface for the purposes of interaction with one cam follower. In such an example, clamping would only occur in one of the open or closed positions of the valve member (preferably the closed condition).

Whilst reference has herein been made to cam surfaces and cam followers, it will be appreciated by a person skilled in the art that such clamping may be established by a leaf spring arrangement being representative of a cam of the kind as hereinbefore described. A leaf spring arrangement may be provided to allow for a cam follower to run up the surface of a leaf spring and progressively allow for relative movement between the upper and lower body portions to be biased in a direction for sealing.

With reference to the FIGS. 41-43 where there is shown discrete ramped surfaces. An alternative to such an arrangement may be the provision of a threaded like arrangement. A threaded like arrangement between the upper and lower body portions can allow for the upper and lower body portions to move closer together to thereby clamp the valve member between the open or closed conditions at desired relative angular rotations of the upper and lower body portions.

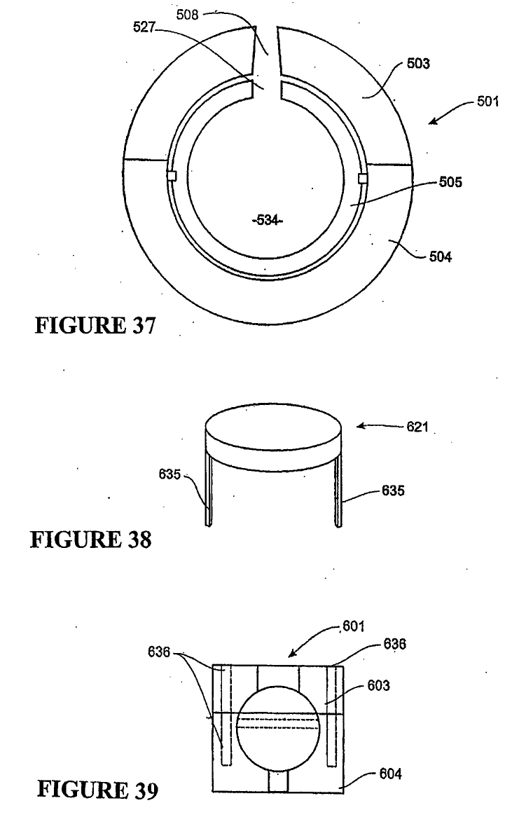

With reference to FIG. 37 there is shown a flow switch assembly 501 that does not include an inlet port. The flow switch assembly 501 includes a lower body portion 504 and an upper body portion 503 movable relative to each other in a manner as previously described and each to interact with a valve member 505. In this example the valve member (or container member) 505 defines a fluid containing reservoir 534. The reservoir 534 can be charged with a fluid or solid to be dispensed via an outlet 527 of the container member 505. The outlet 527 can be moved in and out of communication with an outlet port 508 of the upper body portion 503. When in alignment with the outlet port 508 the fluid or solid or solids contained within the reservoir 534 can be displaced therefrom.

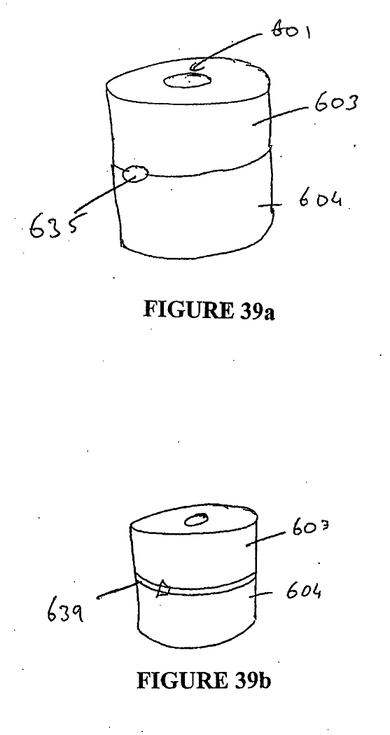

With reference to FIG. 38 there is shown an overcap 621 that has been designed to interact with parts of the flow switch assembly 601 as shown for example in shown in FIG. 39. The flow switch assembly 601 of FIG. 39 may be of a kind as herein described. The overcap 621 includes legs 635 that are capable of locating within apertures or slots 636 of both the upper and lower body portions 603 and 604. However the apertures 636 of each of the upper and lower body portions 603 and 604 may only be in alignment when for example flow switch assembly 601 is in the closed condition as shown in FIG. 39. The overcap 621 may hence only fully engage with the flow switch assembly 601 when the flow switch assembly 601 has been moved to a fully closed condition. In the fully closed condition the legs 635 can extend into the apertures 636 of both upper and lower body portions and be fully seated with the valve assembly and lock relative rotation.

The provision of an overcap 621 that can only engage with a flow switch assembly 601 when the assembly is in a fully closed condition provides the benefit to ensure that the valve is complete closed by a user before the overcap is engaged to the valve assembly. This may have application for example where the valve assembly is used as a valve on a petrol tank of a vehicle. The overcap 621 can hence only be engaged to the flow switch assembly when the petrol tank has been fully closed by the flow switch assembly. This should avoid the flow switch assembly remaining open or partially open. An alternative to the overcap locking mechanism as shown, is a locking pin provided to prevent rotation between the upper and lower body portions. Such a locking pin may extend through apertures of the upper and lower body portions like that shown with reference to the overcap to prevent the relative movement between the upper and lower body portions.

Alternatively the overcap locking mechanism or locking pin may be used to keep the valve in an open position.

With reference to FIG. 39a there is shown an upper and lower body portion wherein a locking element 635 is shown to engage between the upper and lower housing 603 and 604. The locking element may be a pin that can insert between a cavity defined by the upper and lower portions. Other variations will be apparent to a person skilled in the art. Indeed a tamper evident element 639 may be provided to lock the relative rotation together. This is for example shown in FIG. 39b. The tamper evident ring or element 639 may be severable from the upper and lower housing to allow for relative rotation to occur.

FIG. 44 shows part of a flow switch assembly where each of the upper and lower body portions 803/804 includes indexing means 838. The indexing means may for example include a ball bearing 839, part of the upper body portion 803, biased by a spring 840 towards the lower body portion 804. The lower body portion 804 may include a plurality of recesses 841 with each of which the ball bearing 839 can locate. The plurality of recesses 841 may be spaced so that upon relative rotation of the upper and lower body portions an indexed rotation can be established between the upper and lower body portions to discrete relative rotational positions. Such may have application with respect to the variations of the flow switch as shown in FIGS. 33-36.

With reference to FIG. 44a there is shown a variation to that shown in FIG. 44 wherein a ratchet like engagement between the upper body portion 803 and lower body portion 804 occurs. Both the upper and lower body portions may include a ratchet surface or surfaces 843 that can mate with each other for the purposes of locking or providing an interference fit between the upper and lower housings to restrict or restrain or limit relative movement.

With reference to FIG. 40A, there is shown a profiled perimeter surface provided to at least one or both of the upper and lower body portions. FIG. 40A shows a plan view of for example the valve assembly shown in side view in FIG. 40. A hexagonal surfaced region of one or both of the upper and lower body portions may be provided to allow for a crescent or spanner or the like to engage with the valve. In some applications it may not be desirable for relative rotation to be conveniently achieved between the upper and lower body portions but that such rotation can be achieved by the use of a torque applying device such as a wrench or crescent. Indeed in some applications the valve of the present invention may only be desired to be capable of being rotated by authorised personnel. As such specially designed driving devices with certain profiles to engage with an uncommon driving profile provided by one or both of the upper and lower body portions may be provided.

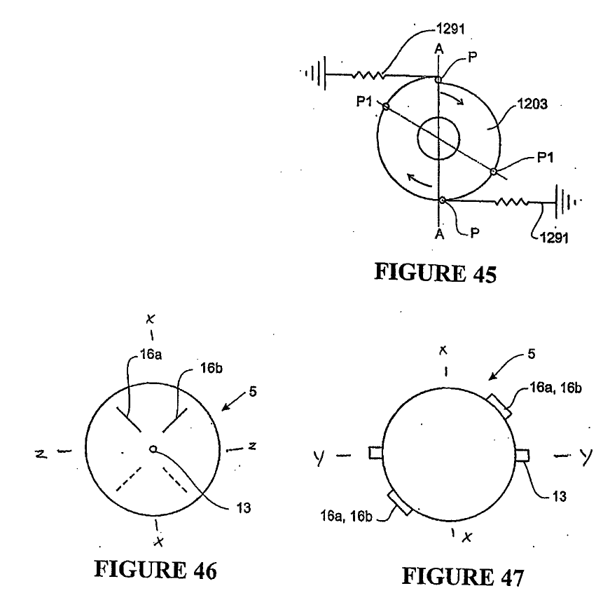

FIG. 45 shows a flow switch assembly wherein one or both of the upper or lower body portions is in part controlled for movement by a spring mechanism. The upper body portion 1203 may have one or two springs 1291 engaged to it the springs biasing the rotation of the upper body portion 1203 towards a certain limit of movement. For example the certain limit of movement may be where the springs are disposed to be positioned on axis AA as shown in FIG. 45. The springs may be coil springs or leaf springs or similar. The springs may work in tension or compression. Other biasing means may also be used.

The upper body portion 1203 may be rotated clockwise such that the points P at where the springs 1291 engage the upper body portion are displaced to positions P₁. The release of the upper body portion 1203 by for example a hand rotating the upper body portion to positions P₁, will result in the upper body portion returning back to the position where the points P are on the axis AA. Such biasing of rotation of the upper body portion 1203 may be to allow for an over centre or toggle position to be assumed by the upper body portion 1203 in relation to the springs 1291. Such an over centre position may allow for the upper body portion 1203 to remain in such a position without having to be held by a hand of a user in such a position. Such a mechanism would operate similar to an over centre toggle latch or spring or the like. The valve that incorporates such a bias as for example shown in FIG. 45 may be used where the flow switch is a boat bung to control the drainage of water into and out of a boat. Other applications will also be apparent to a person skilled in the art.

With reference to FIG. 46 there is shown a variation to the valve member of the present invention described with reference to FIGS. 20-22 wherein the valve member 5 includes the cam lobes 16A and 16B in opposed locations on the valve member on opposite sides of the valve member. This illustrates that it is not essential that the lobe pairing 16A and 16B are provided to one side of a plane extending through the axis at 13 but may be provided on opposite sides. This configuration can offer sharing of the force being transferred to the valve element 5.

However, preferably the lobes 16a and 16b as for example shown with reference to FIG. 25 and FIG. 26, remain above the YX plane. This ensures that no recess, rebate or account needs to be taken for receiving the lobes by the lower body portion of the valve housing. Accordingly rotation of the valve member between its limits, is preferably effected within 180 degrees of its rotation about the Y axis and above the Z-Y plane. In the preferred form however the reaction surfaces of the cam lobes do tend to being or towards being parallel with the ZY plane at least one of the limits of rotation of the valve member. This enhances the force applied by the cam pin 17 in a direction parallel to the X axis and can facilitate in a pushing home of the valve member in its seat for the purposes of sealing.

With reference to FIGS. 48 and 49 there is shown a flow switch assembly illustrating the fact that the inlet and outlet 7, 8 to the valve housing need not be in axial alignment. Indeed the fluid passage 9 through the valve member 5 may be provided so as to allow fluid communication between the inlet and the outlet 7, 8 as shown in the position of the upper and lower body portions 3, 4 in FIG. 48. No fluid communication can be established between the inlet and outlet 7, 8 when the upper and lower body portions 3, 4 are in the rotation orientation shown in FIG. 49.

Wherein reference has been made to the fluid passage 9 or passage for solids, being through the valve member 5 it will be appreciated and with reference to FIGS. 30A and 30B, that the valve member may include a fluid passage defined by the valve member in conjunction with the valve housing for fluid communication between the inlet(s) and outlet(s).

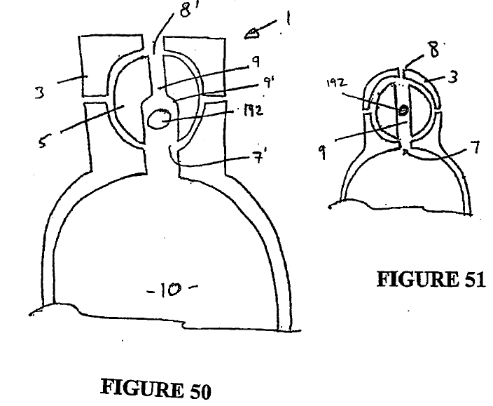

As has hereinbefore been mentioned the flow switch or valve assembly of the present invention may include a tablet or pill or similar. With reference to FIG. 50, there is shown a flow switch assembly 1 wherein such a tablet 192 is located within the passage 9 of the valve member 5. Where the tablet is to be encouraged to be displaced into the container 10, the passage 9 may be of a shape which will prevent the tablet 192 from passing through the outlet port 8′ of the valve member 5. For example the outlet port 8′ of the valve member 5 may be of a smaller size or at least of a size to interfere with the passage of the tablet 192 therethrough, than the inlet port 7′ of the valve member 5. As can be seen with reference to FIG. 50, the inlet port 7′ is of a sufficient size such that when the valve member 5 is rotated to the open position, the tablet 192 can drop through the opening 7′ but cannot pass through the outlet 8′ due to the constriction 9′ of the passage 9 through the valve member 5. In the example shown in FIG. 50, the constriction is provided between the inlet and outlets 7′, 8′. However alternatively the constrictions could be provided at the outlet 8′. With reference to FIG. 51, it can be seen that the constriction is not provided by the passage 9 but rather by the outlet 8 of the upper body portion 3. Again in this configuration the tablet 192 is prevented from passing out through the opening 8 and is rather, encouraged to drop through the inlet opening 7 of the flow switch assembly. In applications where for example the tablet provides a water sterilisation purpose, the configuration of the passage and/or the outlet 8 (or 8′) and the inlet 7 (or 7′) will ensure that the tablet is discharged into the liquid in the container 10 rather than being lost by its passage in the wrong direction through the opening 8.

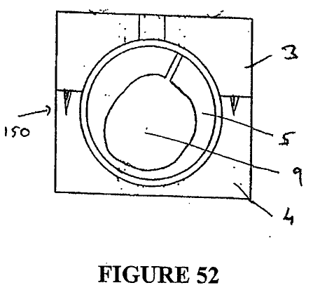

Referring now to FIGS. 20-24 and 52-59 wherein like reference numerals identify similar structural elements or features of the subject invention, there is illustrated in FIG. 20 a flow switch assembly 1.

Reference is made to the description of the invention of PCT/NZ06/000087 which is hereby incorporated by way of reference.

With reference to FIG. 27 there is shown a reference to the valve assembly including the valve member 5 rotating about the axis YY supported by the pivot pins 13. Drawn on the spherical valve member 5, are lines of longitude 50 that extend between the poles at the pivot pins 13. The sphere also includes lines of latitude 51 including the equator line 52 midway between the opposed poles.

As also shown in FIG. 27 is an upper body portion 3 that is shown in an exploded view relative the valve member 5 and wherein it is positioned for rotation about the axis XX. Shown on the upper body portion 3 are its lines of longitude 53 and its lines of latitude 54. Also shown is the cam 17 mounted by the upper body portion 3 and mounted for movement parallel to the latitudinal lines 54. In the preferred form where the XX and YY axes are perpendicular to each other, the lines of latitude 54 of the upper body portion 3 lie parallel to the YY axis. Likewise the lines of latitude 51 of the valve member 5 lie parallel to the XX axis. Positioning of the cam 17 of the upper body portion 3 is preferably such that it is located proximate the axis YY and proximate the poles at pivot pins 13. Interaction of the cam with the cam lobes at this region results in favourable mechanical advantage to be provided during the rotation of the upper body portion 3 about the axis XX with the valve member 5. With reference to FIG. 28, it can be seen that a movement of the cam 17 along a latitudinal line or plane of the upper body portion 3 between its left most limit of movement at 17L and its right most limit of movement at 17R results in the cam 17 traversing across a higher density of longitudinal lines 50 of the valve member 5. In other words, for the same arc traveled by the cam 17 along one of its latitudinal lines the cam will cross more lines of longitude at this more preferred location of the cam, than at an arc that is further from the pole 13 towards the equator 52. Also the further the cam 17 is positioned towards the pole 56 of the upper body portion 3, the less the mechanical advantage will become. In the preferred form the cam 17 has its limits of movement provided on either side of the plane sitting in the X-X and Y-Y axes (i.e. the XY plane).

FIG. 28a illustrates a positioning of the cam 17 in a undesirable position. Referring to FIG. 28a in this position the cam is located proximate the equator 52 of the valve member 5 and moves parallel to the YZ plane (i.e. in a latitudinal line 54 of the upper body portion 3 but only on one side of the XY plane of the valve housing 5). Such positioning of the cam is undesirable as it does not traverse a high density of longitudinal lines 50 of the valve member 5 to effect favorable mechanical advantage. Other inherent problems may also arise.

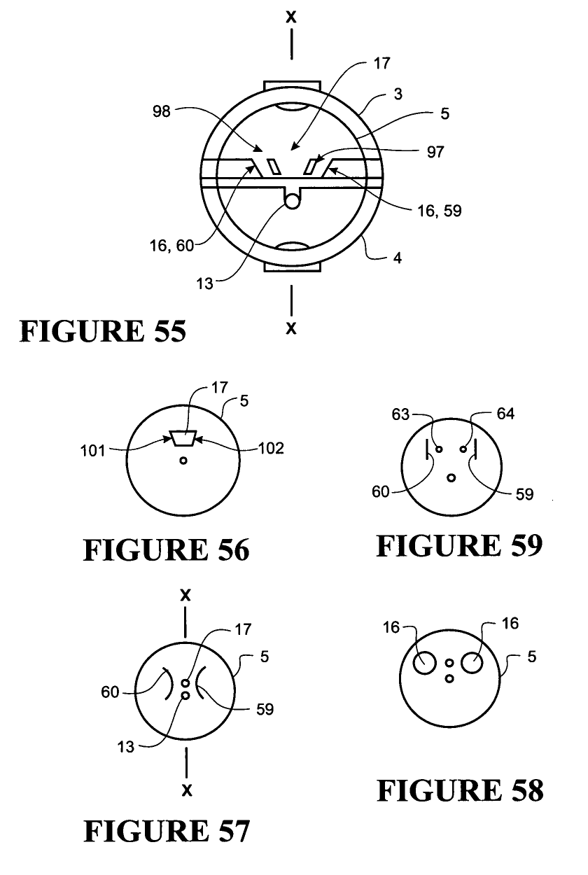

Although not shown in FIGS. 55 and 56, the cam lobes present a reaction surface that may each extend parallel a line of longitude 50 of the valve member. However alternatively the reaction surface may traverse across the line of longitude of the valve member 5. The reaction surface of a cam lobe need not be a straight surface but may be curved yet still allow for the cam 17 to react therewith for the purposes of displacing and rotating the valve member 5 about the YY axis. Such a variation is for example shown with reference to FIG. 28c, where the cam lobes 16a and 16b have reaction surfaces 59 and 60 respectively that each traverse a respective line of longitude 50 of the valve member 5.

Whilst reference herein is made to longitudinal and latitudinal lines having direct reference to a spherical valve element, it will be appreciated that other forms of valve elements will have similar principles at work given that such will still have two poles.

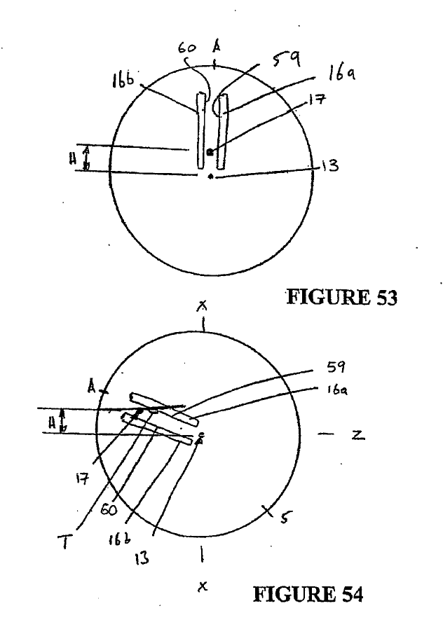

A further variation to the cam lobes is shown with reference to FIGS. 53 and 54 wherein the reaction surfaces 59 and 60 are parallel each other and intermediate of which the cam 17 is placed. FIG. 54 illustrates the cam 17 being displaced to the left side of the XY plane thereby having rotated the valve member 5 in a anticlockwise direction about the YY axis. The reaction surface 60 of the cam lobe 16b has interacted with the cam 17 in rotating the valve in the anticlockwise direction. Rotation of the cam 17 about the XX axis in the opposite direction will result in a returning of the valve member 5 to the position shown in FIG. 53. The return rotation will result in the cam 17 engaging with the reaction surface 59 of the cam lobe 16a. A close positioning of the two reaction surfaces 59 and 60 when the cam is at its extremes of rotation, will result in little or no play existing between the interaction of the cam 17 with the reaction surfaces 60 and 59. Such play can be minimized by a positioning of the cam 17 proximate more the pivot pins 13 where for example the cam lobes are in a V-shaped configuration. They may also be of a U-shaped configuration. The reaction surfaces are preferably straight when locking onto the valve but they may also be curved other than preferably also being curved to follow the surface of the preferred spherical valve member. Alternatively, an appropriate positioning of the V-shaped cam lobes such that their reaction surfaces traverse across the lines of longitude 50 or by having cam lobes that are of or tend towards a parallel configuration as shown in FIGS. 53 and 54 may have similar effect.

However one of the potential disadvantages of proximate parallel cam lobes or equivalent slot as shown in FIGS. 53 and 54 is for example with reference to FIG. 54. Upon the return of the cam 17 to rotate the valve member 5 in a clockwise direction, the angle of incidence of the movement of the cam 17 (parallel to the ZZ plane) with the reaction surface 59, may be an angle that is too shallow and may result in jamming or an un-rotatable valve member. The angle T as shown in FIG. 54 is relatively large and therefore a shallow angle of contact is made between the reaction surface 59 and the cam 17 upon the movement of the cam 17 to rotate the valve member 5 in the clockwise direction. The further that the angle tends towards 90 degrees or zero degrees and away from 180 degrees, the less likely that such jamming will occur.

A person skilled in the art will realize that variations to this preferred configuration can occur including where the XY plane and the ZY planes are not perpendicular of each other.

The degree of play may be dependent on the separation of the reaction surfaces at the latitude of the upper body portion at where the cam is mounted. Alternatively two cams 63, 64 as shown in FIG. 59, or a large cam 17 as shown in FIG. 56 may be provided. Where the surfaces are of a V-shaped configuration, the closer that the cam is mounted towards the apex of the V, the less play there will be. The apex of the V (whether or not the surfaces in fact touch each other) may be at the pole of the valve member or may terminate at a latitude of the valve member away from the pole.

With reference to FIG. 55 there is shown a valve member 5 that carries two cams 97 and 98. In effect the cam 17 in this configuration consists of such two discrete cams 97 and 98 that each interact with respective cam lobes 16 that each define a reaction surface 59 and 60 for a respective cam 97 and 98. In the example shown with reference to FIG. 55, rotation of the lower body portion 4 relative to the upper body portion 3 will result in the displacement of the cam lobes 16 about the rotational axis XX until, depending on the direction of rotation, they make contact with the cam 97/98 of the cam 17.

A variation to the configuration shown in FIG. 55 is where one of the cams 97 is provided proximate more one of the pivot pins 13 of the valve member 5 and another of the elements of the cam 17 is provided proximate more the opposite pivot pin (not shown) of the valve element 5 and wherein respective cam lobes are presented for interaction with the cams 97/98.

With reference to FIG. 56 there is shown a valve member 5 wherein the cam 17 is for example of a trapezoidal shape wherein its interactive surfaces 101 and 102 are provided apart and in a non parallel configuration for interaction with respective reaction surfaces (not shown) of the cam lobes of the upper body portion 3. Here it can be seen that the cam 17 need not necessarily be of a preferred pin or circular plan shape as has hereinbefore been described.

With reference to FIG. 57 there is shown a valve member 5 having a cam 17 presented for interaction with reaction surfaces 59 and 60 that are of a arcuate form. The reaction surface 59 and 60 are presented in the path of travel of the cam 17 about the XX axis independent from the upper body portion 3 so that upon the rotation of the upper body portion 3 about the axis XX, the reaction surfaces 59 and 60 interact with the cam 17 to effect the rotation of the valve member 5 about its pivot pins 13.

FIG. 58 illustrates a variation wherein the reaction surfaces are defined by the cam lobes 16 that are of a circular or oval shape when looking down onto the surface of the valve member 5.

FIG. 59 is a variation wherein the reaction surfaces 59 and 60 are presented by the upper body portion 3 in a substantially parallel condition but with significant separation.

With reference to FIGS. 23 and 24 there is illustrated a flow switch assembly engaged with a beverage container 10. The flow switch assembly 1 as shown in FIGS. 23 and 24, can be threadingly engaged to a beverage container 10 as a result of the beverage container providing a spout 18. The spout is for example integrally formed with the container portion 19. The beverage container 10 may be a blow molded or injection molded (or similar) plastic container and may be of a size sufficient to contain beverages such as water or flavored water or soft drink or the like. The container may include carbonated liquid. The flow switch assembly 1 may include a collar 20 that includes an internal thread which is engageable onto an external thread of the spout 18. A sealing engagement between the valve assembly 1 and the spout 18 can be established so that contents of the beverage container 10 can pass through the spout 18 and be displaced out through the flow switch assembly 1.

1. A flow switch assembly comprising;
a valve housing that includes an upper body portion and a lower body portion that are rotatably engaged relative each other, the upper and lower body portions defining a chamber, the housing including an inlet and outlet to said chamber
a valve member seated in the chamber of the valve housing for movement between a position (herein after “open position”) establishing at least one passage between said inlet and said outlet and a position (herein after “closed position”) wherein said at least one passage between said inlet and said outlet is non-established (preferably by said valve member sealing at least one of said inlet and outlet),
interactive cam elements associated with (i) at least one of (a) said upper body portion and (b) said lower body portion, and (ii) the valve member, the cam elements positioned to effect movement of the valve member between the open position and the closed position when the upper body portion of the housing is rotated relative to said lower body portion.

2. A flow switch assembly as claimed in claim 1 wherein said lower body portion provides said inlet to said chamber, and wherein said lower body portion is integrally formed with a container.

3. A flow switch assembly as claimed in claim 2 wherein said container is a consumer beverage container.

4. A flow switch assembly as claimed in claim 1 wherein a second valve housing is provided, said second valve housing including an upper body portion (the “second upper body portion”) and a lower body portion (the “second lower body portion”), the second upper and lower body portions defining a chamber (the “second chamber”) capturing a valve member (the “second valve member”), the second valve housing including and inlet and outlet to said second chamber,
said second valve member seated in the second chamber of the second valve housing for movement between a position (herein after “open position”) defining a passage (the second passage) between said inlet and said outlet of said second valve housing and a position (herein after “closed position”) wherein said second passage is non-established (preferably by said second valve member sealing at least one of said inlet and outlet of said second chamber),
interactive cam elements associated with said second valve housing and the second valve member for moving the second valve member between the open position and the closed position when the second upper body portion of the second valve housing is rotated relative to said second lower body portion,
wherein a duct is provided intermediate of or defined by said first mentioned upper body portion and said second lower body portion to define a passage between the first mentioned outlet and said second inlet wherein said duct preferably includes an opening.

5. A flow switch assembly as claimed in claim 4 wherein said first mentioned upper body portion is engaged or integrally formed with said second lower body portion.

6. A flow switch assembly as claimed in claim 4 wherein said first mentioned valve member can move independently of said second valve member.

7. A flow switch assembly as claimed in claim 4 wherein said duct retains a tablet.

8. A flow switch assembly as claimed in claim 1 wherein, when said valve member is in said open position, said valve member establishes a plurality of said passages between said inlet and outlet.

9. A flow switch assembly as claimed in claim 1 wherein said valve member includes a plurality of ducts to define at least two of said passages and wherein at least one of said lower and upper body portions includes a plurality of said inlet and outlets respectively, each duct of said plurality of ducts capable, upon the rotation of said valve member, of moving into and out of a said open position being one where at least one passage is established between (i) an or the inlet of said lower body portion and (ii) an or the outlet of said upper body portion.

10. A flow switch assembly as claimed in claim 1 wherein said valve member includes a duct therethrough via which said passage is established, said duct including an outlet opening, said valve member being shaped to present said outlet opening projecting beyond said outlet of said housing when said valve member is in said open position.

11. A flow switch assembly as claimed in claim 1 wherein a removable overcap is provided, said housing engagable with a removable overcap to conceal said outlet of said housing.

12. A flow switch assembly as claimed in claim 1 wherein a ring is provided to engage about at least part of both of said upper and lower body portions to lock relative rotation there between until such time as said ring is released from said upper and lower body portion.

13. A flow switch assembly as claimed in claim 1 wherein said upper and lower body portions include a receptacle to receive a locking element to lock relative rotation of said upper and lower body portions, said receptacle being defined by both said upper and lower body portions.

14. A flow switch assembly as claimed in claim 1 wherein said upper body portion and said lower body portion are rotatably engaged with each other to allow relative rotation about an axis, there being provided by said upper and lower body portions a means cooperative to, at a rotational position of said upper and lower body portions corresponding to the valve member being in at least one of said open and closed position, draw said upper and lower body portions together more to thereby effect a clamping of the valve member by said housing to encourage said valve member to thereby sealingly engage one of said inlet and outlet.

15. A flow switch assembly as claimed in claim 1 wherein said upper body portion and said lower body portion are rotatably engaged with each other to allow relative rotation about an axis, and wherein said upper and lower body portions can displace relative each other in a direction parallel the axis, said displacement controlled by a threaded engagement of said upper and lower body portions said threaded engagement being such that at a rotational position of said upper and lower body portions corresponding to the valve member being in at least one of said open and closed position, said upper and lower body portions are in a more proximate displacement to effect a clamping of the valve member by said housing to encourage said valve member to thereby sealingly engage one of said inlet and outlet.

16. A flow switch assembly as claimed in claim 1 wherein said upper body portion and said lower body portion are rotatably engaged with each other to allow relative rotation about an axis, and wherein said upper and lower body portions can displace relative each other in a direction parallel the axis, said displacement controlled by a ramped surface of at least one of said upper and lower body portions interacting with a reaction surface or like ramped surface of the other of said upper and lower body portion at a rotational position of said upper and lower body portions corresponding to the valve member being in at least one of said open and closed position, said upper and lower body portions are in a more proximate displacement to effect a clamping of the valve member by said housing to encourage said valve member to thereby sealingly engage one of said inlet and outlet.

17. A flow switch assembly as claimed in claim 1 wherein said upper and lower body portions are rotatable relative to each other about an axis, the rotation being indexed by indexing means of said valve housing cooperating between said upper and lower body portions.

18. A flow switch assembly as claimed in claim 1 wherein a spring is provided to bias the rotation of said valve member for rotation towards one of said open and closed conditions.

19. A flow switch assembly as claimed in claim 1 wherein said valve member is mounted by said lower body portion by axles that define an axis of rotation about which said valve member can rotate and relative to which said lower body portion remains stationary and said upper body portion can rotate about said axis relative said lower body portion that is non parallel to said first axis.

20. A consumer beverage container comprising;
a container portion
a lower valve body portion integrally formed with said container portion,
an upper valve body portion rotatably engaged with said lower valve body portion and defining with said lower valve body portion a chamber, said lower valve body portion including at least one passage creating an inlet to said chamber to allow fluid passage between said container portion and said chamber, the upper valve body portion including an outlet to said chamber,
a valve member seated in the chamber, said valve member mounted for movement between a position (herein after “open position”) defining at least one passage between said inlet and said outlet and a position (herein after “closed position”) wherein said at least one passage between said inlet and outlet is non-established (preferably said valve member sealing at least one of said inlet and outlet),
means operatively associated with (i) at least one of (a) said upper and (b) lower valve body portions, and (ii) the valve member, for moving the valve member between the open position and the closed position when the upper valve body portion of the housing is rotated relative to said lower valve body portion.

21. A consumer beverage container including a container defining body having an outlet for transferring fluid to and from said container defining body and a flow switch assembly as claimed in claim 1 to operatively control the transfer of fluid.

22. A consumer beverage container as claimed in claim 20 wherein the lower body portion of said flow switch is integrally formed with said container defining body.

23. A consumer beverage container comprising a container body portion having a flow switch assembly controlled outlet wherein said flow switch assembly is one as claimed in claim 4.

24. A flow switch assembly comprising;
a valve housing that includes an upper body portion and a lower body portion that are rotatable relative each other, the upper and lower body portions defining a chamber, said lower body portion including a plurality of inlets to said chamber and said upper body portion including at least one outlet to said chamber,
a valve member seated in the chamber of the valve housing, said valve member mounted for movement relative to said valve housing between discrete positions each of said discrete positions allowing the establishment by said valve member of a passage between one of said inlets and (a) or the said outlet,
interactive camming elements associated with said valve housing and the valve member for moving the valve member between the discrete positions when the upper body portion of the housing is rotated relative to said lower body portion.

25. A flow switch assembly as claimed in claim 24 wherein said valve member is mounted for movement relative to said valve housing between discrete positions being ones (i) defining of a passage between a said inlet and a or the said outlet and (ii) defining a closed position, wherein said valve member seals at least one of (a) all of said inlets and (b) said outlet(s).

26. A flow switch assembly comprising;
a valve housing that includes an upper body portion and a lower body portion that are rotatably engaged to each other, the upper and lower body portions defining a chamber, said lower body portion including at least one inlet to said chamber and said upper body portion including a plurality of outlets to said chamber,
a valve member seated in the chamber of the valve housing, said valve member mounted for movement relative to said valve housing between discrete positions each of said discrete positions allowing the establishing by said valve member of a passage between (a) or the said inlet and one of said outlets,
interactive cam elements associated with said valve housing and the valve member for moving the valve member between the discrete positions when the upper body portion of the housing is rotated relative to said lower body portion.

27. A flow switch assembly as claimed in claim 26 wherein said valve member is mounted for movement relative to said valve housing between discrete positions being ones (i) defining a passage between one of said outlets and a or the said outlet and (ii) defining a closed position, wherein said valve member seals at least one of (a) all of said outlets and (b) said inlet(s).

28. A container comprising;
a housing that includes an upper body portion and a lower body portion, the upper and lower body portions defining a chamber, the housing including an outlet to said chamber,
a container member seated in the chamber of the housing, said container member including a reservoir to contain a substance and including at least one outlet for said substance, said container member mounted for movement between a position (herein after “open position”) allowing at least one passage to be formed between said outlet of said container member and said outlet to said chamber and a position (herein after “closed position”) wherein said container member seals said outlet of said chamber,
interactive camming elements associated with said housing and the container member for moving the container member between the open position and the closed position when the upper body portion of the housing is rotated relative to said lower body portion.

29. A flow switch assembly as claimed in claim 1 wherein at least one tablet is disposed in said valve member and wherein at least one of
said outlet; and
said passage created when said valve member is in the open condition,
prevents displacement of said tablet through said outlet when said valve member is in the open position yet said inlet is of a shape to allow said tablet to pass therethrough when said valve member is in said open position.

30. A flow switch assembly as claimed in claim 1 wherein said valve element can include a tablet and wherein said outlet is of a shape that prevents the passage of said tablet through said outlet.

31. A flow switch assembly as claimed in claim 1 wherein said outlet is of a smaller size than said inlet.

32. A flow switch assembly as claimed in claim 1 wherein said passage is formed by at least one duct passing through said valve member, said duct having an inlet and an outlet that when in an open position of the valve member are presented to the inlet and outlet of said housing respectively to create said passage.

33. A flow switch assembly comprising;
a valve housing that includes an upper body portion and a lower body portion that are rotatably engaged relative each other, the upper and lower body portions defining a chamber, the housing including an inlet and outlet to said chamber
a valve member seated in said chamber of the valve housing and rotatable about an axis of rotation between two limits of rotation, said valve member including a plurality of ducts each including an inlet and an outlet opening to said inlet and outlet of said housing to create at least two passages between said inlet and outlet of said housing wherein at least one of said passages is created at different rotational positions of said valve member between its limits of rotation,
interactive cam elements operatively associated with (i) at least one of (a) said upper body portion and (b) lower body portion, and (ii) the valve member, for moving the valve member between its limits of rotation when the upper body portion of the housing is rotated relative to said lower body portion.

34. A flow switch assembly comprising;
a valve housing which includes an upper body portion and a lower body portion, the upper and lower body portions defining a chamber to capture a valve member, the housing including an inlet and outlet to said chamber, the upper body portion being rotatable relative the lower body portion and about a first axis of rotation, between a first rotational position and a second rotational position,
a valve member seated in the chamber of the valve housing, said valve member mounted for movement between a position (herein after “open position”) allowing fluid passage between and/or via said inlet and that corresponds to the first rotational position and said outlet and a position (herein after “closed position”) wherein said valve member seals at least one of said inlet and outlet and that corresponds to the second rotational position
at least one cam carried by the upper valve housing for rotational movement along a path about said first axis of rotation
a first cam follower carried by the valve member and presented in the path of the at least one cam when the upper body portion moves between the first position and the second position and towards the second position to be engaged by the at least one cam to thereby displace the valve member towards the closed position,
a second cam follower carried by the valve member and presented in the path of the at least one cam when the upper body portion moves between the first position and the second position and towards the first position to be engaged by the at least one cam to thereby displace the valve member towards the open position.

35. A flow switch assembly as claimed in claim 34 wherein there are two cams, one of which is operative in moving the valve member toward the closed condition by its engagement with the first cam follower upon rotation of the upper housing towards its first position and the other of which is operative in moving the valve member toward the open condition by its engagement with the second cam follower upon rotation of the upper housing towards its second position.

36. A flow switch assembly as claimed in claim 35 wherein each of the two cams are a lug.

37. A flow switch assembly as claimed in claim 34 wherein the valve member is mounted for rotational movement within the housing about an axis of rotation (herein after “second axis of rotation”) that is non parallel the first axis of rotation.

38. A flow switch assembly as claimed in claim 34 wherein the first cam follower is positioned proximate more a first of the axles as is its corresponding cam.

39. A flow switch assembly as claimed in claim 34 wherein the second cam follower is positioned proximate more the first of the axles as its corresponding cam.

40. A flow switch assembly as claimed in claim 34 wherein the second cam follower is positioned proximate more the second of the axles as is its corresponding cam.

41. A flow switch assembly as claimed in claim 34 wherein the first and second cam followers are positioned radially relative to the axle.

42. A flow switch assembly as claimed in claim 34 wherein when said valve member is in said open position, said valve member establishes at least one passage to allow fluid communication between said inlet and outlet.

43. A flow switch assembly as claimed in claim 34 wherein said valve member is mounted by said chamber for rotation relative to said valve housing, about a first axis.

44. A flow switch assembly as claimed in claim 34 wherein each of the cam followers is formed at the exterior surface of the valve member and a cam(s) is formed on the interior surface of the upper body portion of the housing.

45. A flow switch assembly as claimed in claim 34 wherein each of the cam followers is formed into the valve member.

46. A flow switch assembly as claimed in claim 34 wherein said lower body portion provides said inlet to said chamber, and wherein said lower body portion is integrally formed with a container said container including an opening contiguous said inlet to said chamber.

47. A consumer beverage container comprising;
a container portion that includes a lower valve body portion integrally formed with said container portion,
an upper valve body portion, rotatably engaged with said lower valve body portion and defining with said lower valve body portion a chamber to capture a valve member, said lower valve body portion including a passage creating an inlet to said chamber to allow fluid passage between said container portion and said chamber, the upper valve body portion including an outlet to said chamber,
a valve member seated by the chamber, said valve member mounted for movement between a position (herein after “open position”) allowing fluid passage between and/or via said inlet and said outlet and a position (herein after “closed position”) wherein said valve member seals at least one of said inlet and outlet,
a cam of at least one of (a) said upper and (b) lower valve body portions, and two cam followers of the valve member, to interact with each other for moving the valve member between the open position and the closed position when the upper valve body portion of the housing is rotated relative to said lower valve body portion.

48. A fluid container comprising;
a housing which includes an upper body portion and a lower body portion, the upper and lower body portions defining a chamber capturing a container member, the housing including an outlet to said chamber,
a container member seated by the chamber of the housing, said container member including a reservoir to contain fluid and including at least one fluid outlet, said container member mounted for movement between a position (herein after “open position”) allowing fluid passage between and/or via said fluid outlet of said container member and said outlet to said chamber and a position (herein after “closed position”) wherein said container member seals said outlet of said chamber,
a cam of at least one of (a) said upper and (b) lower valve body portions, and two cam followers of the valve member, to interact with each other for moving the valve member between the open position and the closed position when the upper valve body portion of the housing is rotated relative to said lower valve body portion.

49. A fluid container as claimed in claim 48 wherein said container member includes only one fluid outlet which is rotatable relative to and to be contiguous with said outlet of said housing when said container member is rotated to said open position.

50. A fluid container as claimed in claim 48 wherein when said container member is in said open position, said container member establishes at least one passage to allow fluid communication between said fluid outlet and outlet of said housing.

51. A fluid container as claimed in claim 48 wherein the moving of said container member between the open position and the closed position by the interaction of the cam and cam followers is actuated when the upper body portion of the housing is rotated relative to said lower body portion about an axis which is perpendicular to said first axis.
